(19) United States
(12) Patent Application Publication
(10) Pub. No.: US 2019/0344798 A1
(43) Pub. Date: Nov. 14, 2019

(54) INFORMATION PROCESSING SYSTEM, INFORMATION PROCESSING METHOD, AND RECORDING MEDIUM

(71) Applicant: Panasonic Intellectual Property Management Co., Ltd., Osaka (JP)

(72) Inventors: HIDETO MOTOMURA, Kyoto (JP); HISAJI MURATA, Osaka (JP); ERIKO OHDACHI, Kanagawa (JP); MASANAGA TSUJI, Osaka (JP); KOICHI EMURA, Kanagawa (JP); SAHIM KOURKOUSS, Osaka (JP)

(21) Appl. No.: 16/523,776

(22) Filed: Jul. 26, 2019

Related U.S. Application Data
(63) Continuation of application No. PCT/JP2018/004959, filed on Feb. 14, 2018.

(30) Foreign Application Priority Data
Feb. 23, 2017 (JP) 2017-032574

(51) Int. Cl. B60W 40/09; G05D 1/02

(52) U.S. Cl. CPC B60W 40/09; G05D 2201/0213; G05D 1/0214

(57) ABSTRACT

An information processing system includes a safe behavior determiner, clustering range controller, and safety determiner. The safe behavior determiner classifies parameter values indicating a travel state of a vehicle into multiple ranges based on travel safety. The safe behavior determiner also determines a safe behavior for the vehicle by which the travel state of the vehicle is adjusted such that the parameter values fall under a safety range with high travel safety. The clustering range controller changes a position of a boundary between the ranges according to an external environment of the vehicle. The safety determiner acquires a behavior estimation result of the vehicle and the safe behavior determined by the safe behavior determiner, and determines behavior control of the vehicle on the basis of at least the acquired behavior estimation result or safe behavior.

### CROSS-REFERENCE TO RELATED APPLICATIONS

This application is a continuation of the PCT International Application No. PCT/JP2018/004959 filed on Feb. 14, 2018, which claims the benefit of foreign priority of Japanese patent application No. 2017-032574 filed on Feb. 23, 2017, the contents all of which are incorporated herein by reference.

### BACKGROUND

### 1. Technical Field

The present disclosure relates to an information processing system, an information processing method, and a recording medium for processing information on vehicles.

### 2. Description of the Related Art

Recently, automated driving technologies for vehicles, such as cars, traveling on roads have been discussed. For example, Japanese Patent Unexamined Publication No. 2005-67483 discloses a vehicle travel control device. This travel control device makes a driver visually recognize the operation state of an automatic steering control or an automatic speed control when the driver's vehicle is switched to the automatic steering control or the automatic speed control.

### SUMMARY

An information processing system like the travel control device in Japanese Patent Unexamined Publication No. 2005-67483 may fail to estimate a precise driving operation to be applied to a vehicle. In other words, there is a risk of incorrect (or incorrectness risk) in the vehicle behavior estimation.

The present disclosure offers an information processing system, an information processing method, and a recording medium storing a program that can reduce a risk of incorrect estimation in the vehicle behavior estimation.

An information processing system in an aspect of the present disclosure includes a safe behavior determiner, a clustering range controller, and a safety determiner. The safe behavior determiner classifies parameter values each indicating a travel state of a vehicle into multiple ranges based on travel safety. The safe behavior determiner also determines a safe behavior for the vehicle. The safe behavior adjust the travel state of the vehicle such that the parameter values fall under a safe range with high level of the travel safety. The clustering range controller changes a position of a boundary between the multiple ranges in accordance with the external environment of the vehicle. The safety determiner acquires a behavior estimation result of the vehicle and the safe behavior determined by the safe behavior determiner, and determines a behavior control of the vehicle based on at least one of the acquired estimation result and the safe behavior.

According to an information processing method in an aspect of the present disclosure, parameter values each indicating a travel state of a vehicle are acquired, and these parameter values are classified into multiple ranges based on travel safety. Then, a position of a boundary between these ranges is changed in accordance with an external environment of the vehicle. Still more, a safe behavior for the vehicle is determined. By the safe behavior, the travel state of the vehicle is adjusted such that the parameter values fall under a range with a high level of the travel safety among the multiple ranges. A behavior estimation result of the vehicle is then acquired, and a behavior control of the vehicle is determined based on at least this behavior estimation result and the aforementioned safe behavior.

A program in an aspect of the present disclosure executes the above information processing method by a computer. This program can be provided by recording the program in a non-transitory recording medium.

These comprehensive or specific aspects may be achieved by a system, a method, an integrated circuit, a computer program, or a recording medium readable by a computer, such as a CD-ROM. They can also be achieved by any given combination of a system, a method, an integrated circuit, a computer program, and a recording medium.

The information processing system of the present disclosure can reduce a risk of incorrect in the vehicle behavior estimation.

### BRIEF DESCRIPTION OF DRAWINGS

FIG. 1 is a functional block diagram of an information processing system and peripheral components thereof in accordance with a first exemplary embodiment.

FIG. 2 is a diagram showing an example of function configuration of a behavior estimation by a learner and a behavior estimator in FIG. 1.

FIG. 3 is a diagram showing another example of function configuration of behavior estimation by the learner and behavior estimator in FIG. 1.

FIG. 4 illustrates learning by the learner.

FIG. 5A illustrates learning in a neural network.

FIG. 5B illustrates learning in the neural network.

FIG. 6A is a diagram illustrating an example of behavior estimation by a dedicated behavior estimation neural network.

FIG. 6B is a diagram illustrating another example of behavior estimation by the dedicated behavior estimation neural network.

FIG. 7A is a diagram illustrating an example of behavior estimation by the dedicated behavior estimation neural network.

FIG. 7B is a diagram illustrating an example of behavior estimation by the dedicated behavior estimation neural network.

FIG. 8 is a diagram illustrating an example of a travel state radar chart.

FIG. 9 is a diagram illustrating an example of vehicle speed distribution.

FIG. 10A is an example of a travel state radar chart indicating a real-time travel state of a vehicle.

FIG. 10B is a travel state radar chart in which the travel state indicated in the travel state radar chart in FIG. 10A is changed to a safer state.

FIG. 11 is a sequence diagram illustrating an example of a flow of operations in the information processing system and peripheral thereof.

FIG. 12 is a sequence diagram illustrating another example of a flow of operations in the information processing system and peripheral thereof.

FIG. 13 is a diagram illustrating an example of an indication of a shift to a safe behavior on a display device in the information processing system.

FIG. 14 is a functional block diagram of an information processing system and peripheral components thereof in accordance with a second exemplary embodiment.

FIG. 15A is a diagram illustrating an example of a travel state in a comfort range displayed on a display screen of a display device.

FIG. 15B is a diagram illustrating an example of a travel state in a hazard range displayed on the display screen of the display device.

FIG. 16 is an example of a reference travel state radar chart.

FIG. 17 is an example of a travel state radar chart in a case where a road on which a vehicle travels has an accident record.

FIG. 18 is an example of a travel state radar chart in a case where traffic is heavy on a road on which a vehicle travels.

FIG. 19 is an example of a travel state radar chart in a case where traffic is light on a road on which a vehicle travels and the weather is fine.

FIG. 20 is an example of a travel state radar chart in a case where a vehicle is traveling on a road that is used on a daily basis.

### DETAILED DESCRIPTION OF PREFERRED EMBODIMENTS

The travel control device disclosed in Japanese Patent Unexamined Publication No. 2005-67483 controls vehicle travel according to vehicle location information acquired by GPS (Global Positioning System) of an onboard car navigation device. In addition to vehicle positioning using GPS, the inventors have studied automated driving technology using results of detecting the surrounding environment of the vehicle by various detectors including a camera, a millimeter wave radar, and an infrared sensor. Levels of automated driving include full automation, and partial automation for assisting driver's operation. In the full automation, operations and decision-making by driver is not needed. In the automated driving technology, behaviors that a vehicle may take are estimated, based on vehicle-related information including a driving route and surroundings, and the most appropriate behavior is determined among estimated behavior candidates. Then, driving of a vehicle is controlled according to the determination result. The inventors have studied a vehicle behavior estimation method employing a machine learning using a large amount of learning data built in advance. In such a machine learning, drive records, travel records, and other records along with the vehicle travels are continuously incorporated in the learning data to be used for estimating behaviors. However, even in behavior estimation using the machine learning, the inventors have revealed that a risk of incorrect in a behavior estimation result remains due to reasons such as insufficient volume of accumulated data or no data corresponding to a condition concerned. The inventors have then studied how to reduce this risk of incorrect and reached a technology disclosed in the claims and the following description.

An information processing system, an information processing method, a program, and a recording medium according to the exemplary embodiments are described below with reference to drawings. The exemplary embodiments described below are comprehensive or specific embodiments. Numerical values, shapes, materials, components, layout and connection of components, steps (processes), sequence of steps, and so on are examples and thus do not limit the intention of the present disclosure. Still more, components in the exemplary embodiments that are not described in an independent claim indicating the most generic concept are described as arbitrary components. Still more, description of the exemplary embodiments below may use an expression accompanied by ‘substantially,’ such as substantially parallel and substantially orthogonal. For example, substantially parallel includes not only complete parallel but also practically parallel. In other words, for example, it includes a difference of about several percent. This is also same for other expressions accompanied by ‘substantially.’

### First Exemplary Embodiment

[1-1. Configuration of Information Processing System According to First Exemplary Embodiment]

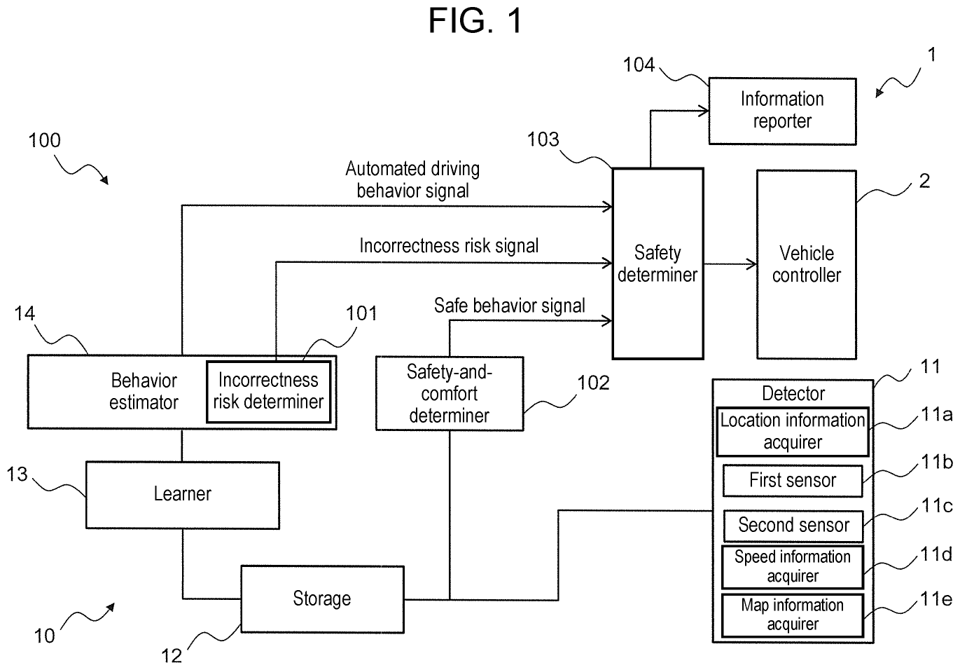

First is described configuration of information processing system 100 according to a first exemplary embodiment with reference to FIG. 1. FIG. 1 is an example of a functional block diagram of information processing system 100 and its peripheral components according to the first exemplary embodiment. In the present exemplary embodiment, information processing system 100 is installed in vehicle 1 that can travel on a road, such as a car, truck, and bus, for example. Information processing system 100 is a part of automated driving control system 10 for entirely or partially controlling driving of vehicle 1 without any operation by a driver of vehicle 1. Installation of information processing system 100 is not limited to vehicle 1. It can be any other moving objects, such as an aircraft, a ship, and an unmanned carrier. Information processing system 100 in the present exemplary embodiment determines a behavior in a preset safety range as a behavior to be performed when correctness of behavior estimation by automated driving control system 10 is low.

As shown in FIG. 1, vehicle 1 includes vehicle controller 2, automated driving control system 10, and information processing system 100. Vehicle controller 2 controls entire vehicle 1. For example, vehicle controller 2 may be realized by an LSI circuit (Large Scale Integration circuit), or a part of an electronic controller (ECU) that controls vehicle 1. Vehicle controller 2 controls vehicle 1 in accordance with information received from automated driving control system 10 and information processing system 100. Vehicle controller 2 may include automated driving control system 10 and information processing system 100.

Automated driving control system 10 includes detector 11, storage 12, learner 13, and behavior estimator 14. Information processing system 100 includes incorrectness risk determiner 101, safety-and-comfort determiner 102 as a safe behavior determiner, and safety determiner 103. Information processing system 100 may further include information reporter 104 for providing information on information processing results to an occupant of vehicle 1. In the present exemplary embodiment, behavior estimator 14 also functions as incorrectness risk determiner 101. However, incorrectness risk determiner 101 may be separately provided from behavior estimator 14. Components of detector 11 and components such as learner 13, behavior estimator 14, incorrectness risk determiner 101, safety-and-comfort determiner 102, safety determiner 103, and information reporter 104, which are described later, may be configured with dedicated hardware, or may be realized by executing a software program suitable for each component. Each component may also be realized by reading and executing a software program recorded in a recording medium, such as a hard disk and semiconductor memory, by a CPU (Central Processing Unit) or program execution part, such as a processor.

Detector 11 detects the travel state and surroundings of vehicle 1. Detector 11 then outputs the detected information on travel state and surroundings to vehicle controller 2. Detector 11 also stores the detected information into storage 12. Detector 11 includes, although not limited, location information acquirer 11a, first sensor 11b, second sensor 11c, speed information acquirer 11d, and map information acquirer 11e.

Location information acquirer 11a acquires information on location of vehicle 1 from GPS positioning results by a car navigation device installed in vehicle 1. First sensor 11b detects surroundings of vehicle 1. For example, first sensor 11b detects location of other vehicle that exists around vehicle 1 and traffic lane position information, and also detects a location type of other vehicle, such as a leading vehicle of vehicle 1. For example, first sensor 11b also detects time to collision (TTC) between other vehicle and the speed of vehicle 1, based on the speed of each of the two vehicles. For example, first sensor 11b also detects location of an obstacle that exists around vehicle 1. Such first sensor 11b may include a millimeter wave radar, a laser radar, a camera, or their combination.

Second sensor 11c acquires information on vehicle 1 itself. For example, second sensor 11c includes load sensors disposed to seats of vehicle 1 to detect the number of occupants of vehicle 1. For example, second sensor 11c includes a rotation sensor for a steering wheel of vehicle 1 to detect a steering angle of vehicle 1. For example, second sensor 11c includes a brake sensor of vehicle 1 to detect a brake intensity. For example, second sensor 11c includes an accelerator sensor of vehicle 1 to detect an accelerator position. For example, second sensor 11c includes an indicator sensor for vehicle 1 to detect a direction indicated by the indicator.

Speed information acquirer 11d acquires information on the travel state of vehicle 1. For example, speed information acquirer 11d acquires information on speed and travel direction of vehicle 1 from a speed sensor (not illustrated) of vehicle 1 as the above information. Map information acquirer 11e acquires map information on surroundings of vehicle 1. For example, map information acquirer 11e acquires map information on a road on which vehicle 1 travels, a junction point with other vehicles on the road, a currently-traveling traffic lane on the road, and location of an intersection on the road as the above map information.

Storage 12 is a storage device, such as a ROM (Read Only Memory), a RAM (Random Access Memory), a hard disk device, and an SSD (Solid State Drive). Storage 12 stores various pieces of information, including detection results of detector 11, knowledge (also called machine learning data) for estimating behavior by automated driving control system 10, neural network to be used for machine learning, which is described later, and information to be used by information processing system 100, which is described later. Storage 12 also stores a correspondence relation between the current travel environment of vehicle 1 and candidates of behavior that vehicle 1 possibly takes.

Learner 13 constructs machine learning data for estimating a behavior corresponding to a driver of vehicle 1. In the present exemplary embodiment, learner 13 employs a neural network (hereinafter referred to as ‘N’) for machine learning. However, other machine learning approaches are also applicable. The neural network is an information processing model inspired by a cerebral nervous system. The neural network consists of multiple node layers including an input layer and an output layer. Each node layer includes one or more nodes. Mode information of the neural network indicates the number of node layers configuring the neural network, the number of nodes in each node layer, and type of entire neural network or each node layer. For example, when the neural network is configured with three node layers, i.e., an input layer, an intermediate layer, and an output layer, the number of nodes in the input layer can be, for example, 100; the intermediate layer 100, and the output layer 5. The neural network sequentially performs an output processing from the input layer to the intermediate layer, a processing in the intermediate layer, an output processing from the intermediate layer to the output layer, and a processing in the output layer with respect to information input to the node in the input layer, and then outputs an output result conforming to the input information. Each node in each layer is connected to each node in the subsequent layer, and each connection between the nodes is weighted. Node information in one layer is given a weight assigned to a connection between the nodes, and output to the node in the subsequent layer.

Learner 13 constructs a neural network for specific driver x using drive records of driver x of vehicle 1. Alternatively, learner 13 may construct a neural network for driver x using the drive records of driver x and general drive records of multiple drivers other than driver x. Or, learner 13 may construct a neural network for driver x using travel records of driver x of vehicle 1. Or, learner 13 may construct a neural network for driver x using the travel records of driver x of vehicle 1 and general travel records of multiple drivers other than driver x. Learner 13 may construct a neural network using at least one of the drive records of driver x, the drive records of driver x and the general drive records, the travel records of driver x, and the travel records of driver x and the general travel records. Here, the multiple drivers are many and unspecified drivers without being related to vehicle 1. Learner 13 outputs the constructed neural network as behavior estimation NN to behavior estimator 14.

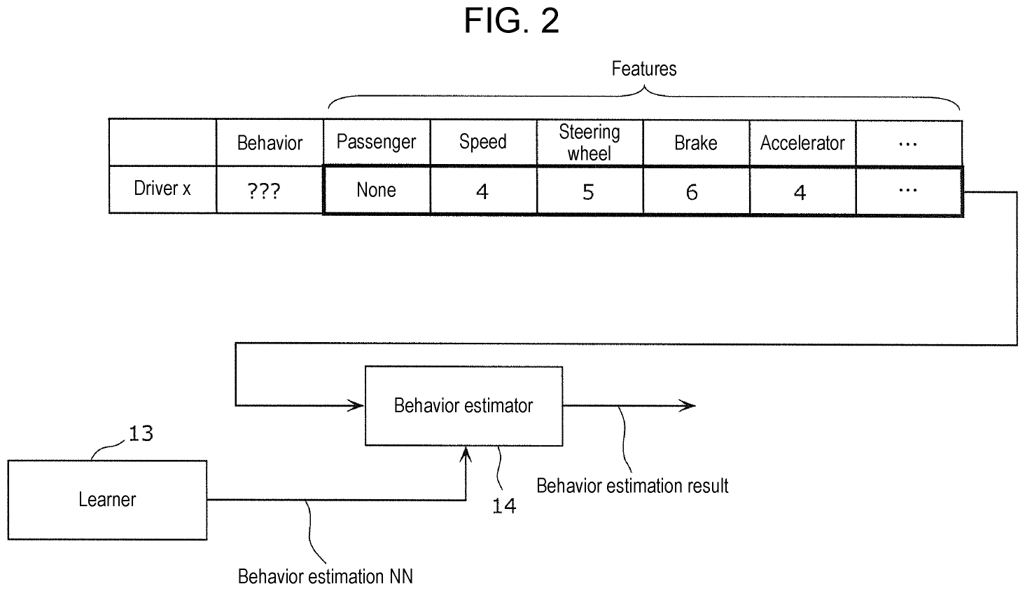

The drive records is constructed such that each past vehicle behavior is associated with multiple features (hereinafter also called ‘feature set’). Each feature associated with behavior is, for example, an amount indicating the travel state of the vehicle from the time that the vehicle starts that behavior to the time before a predetermined time will pass. The predetermined time may be a preset time, and it may typically be a time until next behavior starts. The general drive records are drive records of many and unspecified vehicles. For example, as shown in FIG. 2, a behavior and associated feature set are combined and stored into storage 12. FIG. 2 is a diagram illustrating an example of function configuration of a behavior estimation by learner 13 and behavior estimator 14 of FIG. 1. Features are parameters related to the vehicle behavior. For example, they are the number of occupants of the vehicle, a vehicle speed, steering wheel movement (also called ‘steering’), a brake level (also called ‘intensity’), and an acceleration level (also called ‘opening’). The features include, for example, the vehicle travel state detected by detector 11.

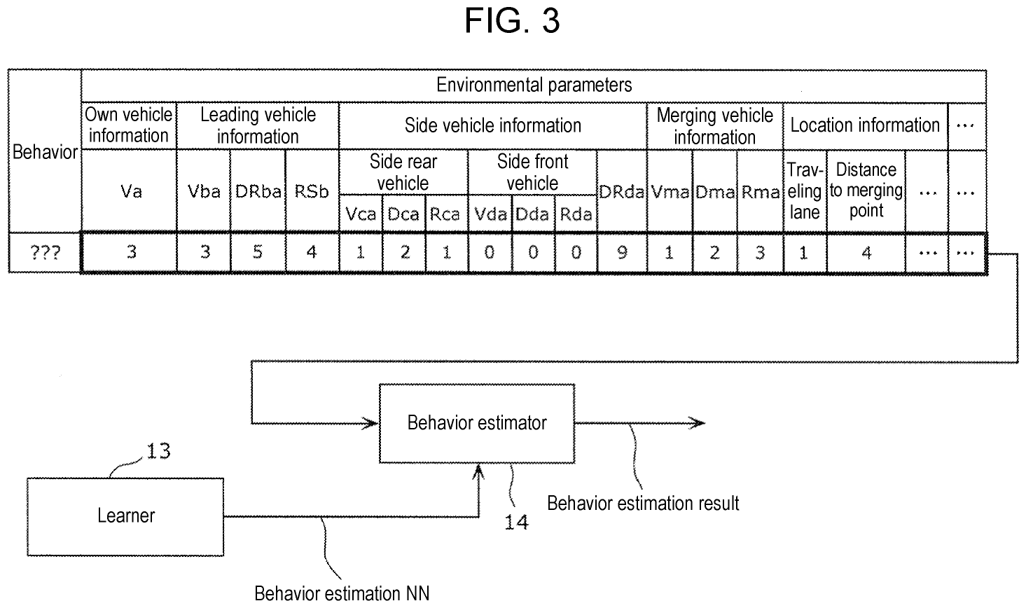

The travel records are constructed such that each past vehicle behavior is associated with multiple environmental parameters (hereinafter also called ‘environmental parameter set’). An environmental parameter associated with a behavior is, for example, an amount indicating surroundings of vehicle 1, i.e., environment of vehicle 1 from the time that the vehicle takes that behavior to the time before a predetermined time will pass. The general travel records are travel records of many and unspecified vehicles. For example, as shown in FIG. 3, a behavior and an environmental parameter set associated with the behavior are combined and stored into storage 12. FIG. 3 shows another example of function configuration of behavior estimation by learner 13 and behavior estimator 14 of FIG. 1. Environmental parameters relates to the environment around the vehicle. For example, the parameters include driver's vehicle (own vehicle) information such as speed Va, information on a leading vehicle relative to the driver's vehicle such as relative speed Vba and vehicle distance DRba, information on a side vehicle relative to the driver's vehicle such as relative speed Vca and distance between vehicle heads Dca, information on a merging vehicle relative to the driver's vehicle such as relative speed Vma and distance between vehicle heads Dma, and location information on the driver's vehicle. The environmental parameters are, for example, surroundings of the vehicle detected by detector 11.

Behavior estimator 14 inputs at least the feature set or environmental parameter set acquired at the current moment as test data to behavior estimation NN constructed by learner 13, and outputs a behavior corresponding to the input information as an estimated behavior. In other words, for example, behavior estimator 14 outputs a behavior estimation result after the predetermined time will pass.

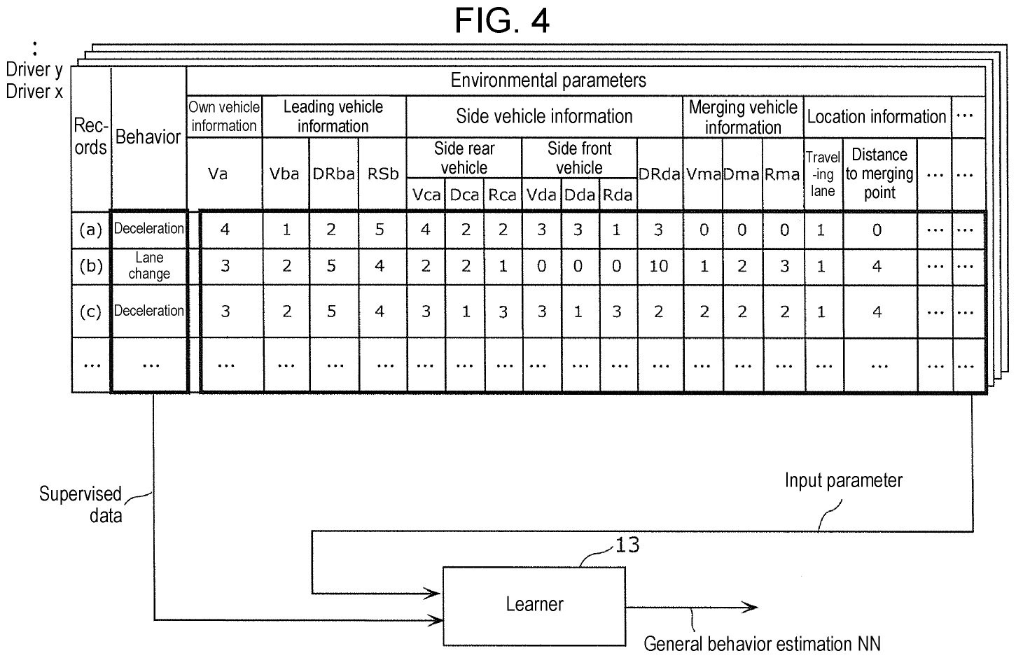

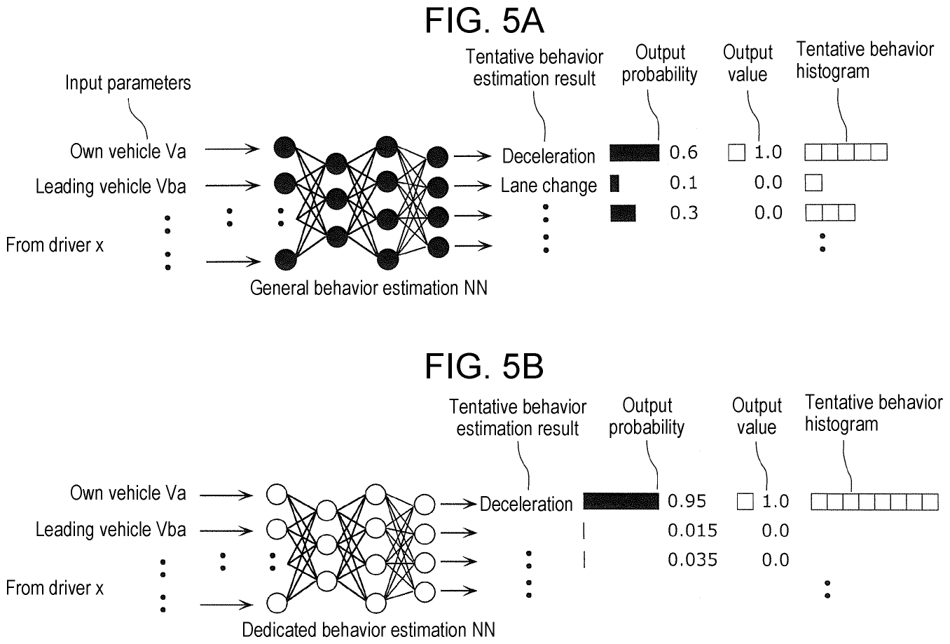

Learner 13 and behavior estimator 14 are further detailed, taking a case where learner 13 constructs behavior estimation NN of specific driver x, using the travel records of driver x and the general travel records, with reference to FIG. 4, FIG. 5A, and FIG. 5B. FIG. 4 illustrates learning by learner 13. FIG. 5A and FIG. 5B illustrate learning by the neural network.

As shown in FIG. 4, learner 13 constructs a general neural network as general behavior estimation NN, using the general travel records of multiple drivers. More specifically, learner 13 inputs environmental parameters included in the general travel records of unspecified drivers to the neural network as input parameters. Learner 13 then optimizes weights between nodes of the neural network so that an output from the neural network matches supervised data that is a behavior associated with the input parameters. This optimization takes place on the basis of the travel records of multiple drivers, in addition to the travel records of one driver. By this weight adjustment, learner 13 makes the neural network learn a relation between the input parameters and supervised data, so as to construct general behavior estimation NN corresponding to unspecified drivers.

Next, learner 13 adjusts general behavior estimation NN, using the travel records of specified driver x, to construct dedicated behavior estimation NN corresponding to driver x. Learner 13 inputs a specific behavior included in the travel records of driver x and an environmental parameter set associated with this behavior to general behavior estimation NN, thereby adjusting weights between nodes of general behavior estimation NN and so as to acquire supervised data, which is the above specific behavior, as an output. More specifically, learner 13 estimates tentative behaviors in which the specific behavior included in the travel records of specified driver x is set as supervised data, using general behavior estimation NN. At this time, learner 13 acquires the specific behavior included in the travel records of specified driver x as supervised data, and then acquires the environmental parameter set associated with this behavior as input parameters. In an example shown in FIG. 5A, a behavior ‘deceleration’ is acquired as supervised data, and the environmental parameter set corresponding to the behavior ‘deceleration’ is acquired as input parameters. When multiple environmental parameters corresponding to the supervised data exist, learner 13 acquires each of these environmental parameters as an input parameter. Learner 13 then inputs the input parameters to general behavior estimation NN sequentially. As a result of these inputs to general behavior estimation NN, learner 13 acquires estimation results of various behaviors, such as ‘lane change’ in addition to ‘deceleration,’ as tentative behavior estimation results when ‘deceleration,’ for example, is selected as the supervised data that is the specific behavior.

For example, as shown in FIG. 5A, output results acquired by inputting the environmental parameters corresponding to the supervised data to general behavior estimation NN include an output probability of each behavior in the tentative behavior estimation results, in addition to the tentative behavior estimation results. The output probability of each behavior is a probability of outputting each behavior when an environmental parameter set with a configuration same as the above environmental parameter set is input to general behavior estimation NN. The behavior output probability shows a degree of correctness of the behavior, and can indicate reliability of the behavior. In the present exemplary embodiment, the output probability is indicated with values between 0 and 1. Without being limited, however, the probability can also be indicated using percentage (%). When the output probability is indicated using values between 0 and 1, the sum of output probabilities of behaviors becomes 1 in the output.

Still more, learner 13 gives output value ‘1’ to a behavior with the highest output probability and gives output value ‘0’ to behaviors other than the behavior, with respect to each behavior in the tentative behavior estimation results acquired. Learner 13 then generates a tentative behavior histogram of behaviors, using the output values. The tentative behavior histogram indicates accumulated output values of behaviors in the tentative behavior estimation results relative to a behavior of supervised data. For example, FIG. 5A shows the case where the supervised data is ‘deceleration.’ Output values of behaviors acquired as a result of inputting various environmental parameter sets, using ‘deceleration’ as the supervised data, to general behavior estimation NN are accumulated, and the accumulated output values are indicated by the tentative behavior histogram of each behavior. FIG. 5A shows an example that the output probability of the behavior ‘deceleration’ in the tentative behavior estimation results is 0.6, which is the maximum, as a result of inputting the environmental parameter sets corresponding to supervised data ‘deceleration’ to general behavior estimation NN. In this case, output value “1” is added to the tentative behavior histogram for ‘deceleration,’ which is already generated in the past learning results. Tentative behavior histograms for behaviors ‘deceleration’ and ‘lane change’ in the tentative behavior estimation results in FIG. 5A show that accumulated output values for behaviors ‘deceleration’ and ‘lane change’ that are output when the environmental parameter set corresponding to supervised data ‘deceleration’ of driver x is input to general behavior estimation NN.

Learner 13 then constructs dedicated behavior estimation NN by learning again weights between nodes of general behavior estimation NN so as to increase the matching rate of the output of general behavior estimation NN and supervised data on the basis of the tentative behavior histogram. As shown in FIG. 5B, learner 13 constructs dedicated behavior estimation NN such that only the output value for ‘deceleration’ that is a behavior in the supervised data is added to the tentative behavior histogram when the environmental parameter set corresponding to supervised data ‘deceleration’ is input. In other words, dedicated behavior estimation NN is constructed such that the behavior ‘deceleration’ in the tentative behavior estimation results has the highest output probability when the environmental parameter set corresponding to supervised data ‘deceleration’ is input. For example, in the example in FIG. 5B, dedicated behavior estimation NN increases the output probability of the behavior ‘deceleration’ to as high as 0.95. This kind of relearning takes place not only for one piece of supervised data but for each of multiple other pieces of supervised data. In other words, learner 13 constructs a neural network exclusive for predetermined driver x by transfer of learning.

Behavior estimator 14 uses dedicated behavior estimation NN for driver x and the currently acquired environmental parameter set for driver x for typically estimating a behavior of vehicle 1 after a predetermined time will pass. More specifically, behavior estimator 14 inputs the environmental parameter set as input parameters to dedicated behavior estimation NN. As a result, behavior estimator 14 acquires a tentative behavior output from dedicated behavior estimation NN as a tentative behavior estimation result, and outputs a probability of the tentative behavior included in the acquired tentative behavior estimation result. The tentative behavior output from dedicated behavior estimation NN corresponds to the environmental parameter set, and is a candidate behavior to be performed corresponding to the environmental parameter set.

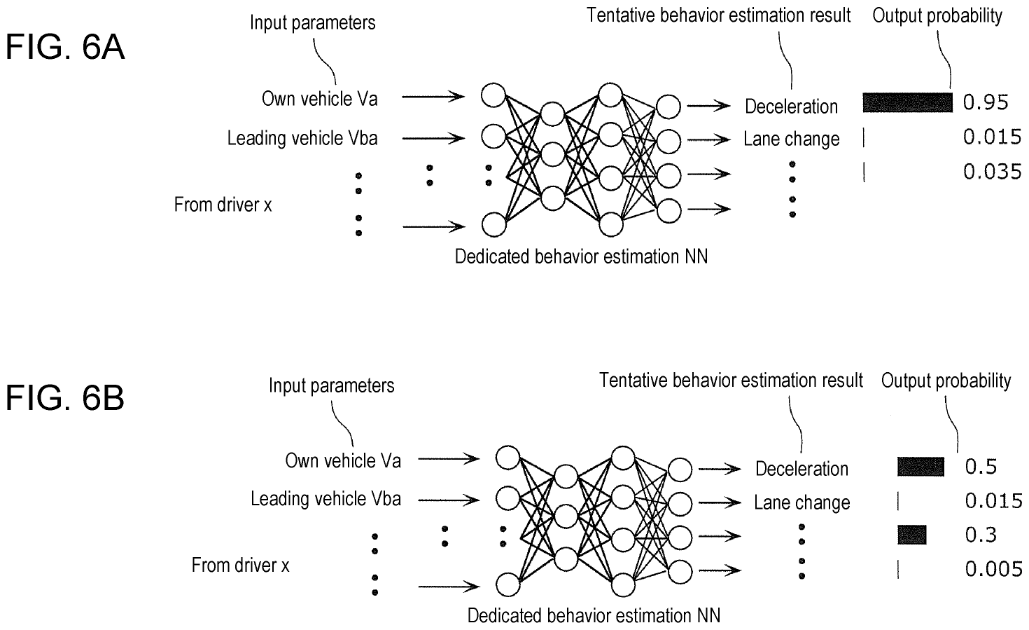

For example, as shown in FIG. 6A, when the environmental parameter set typically including driver's vehicle speed Va and leading vehicle speed Vba is input to dedicated behavior estimation NN, behaviors, such as ‘deceleration’ and ‘lane change,’ are output as the tentative behavior estimation results. An output probability of each behavior is also output. In FIG. 6A, for example, the output probability of the behavior ‘deceleration’ is 0.95, and the output probability of behavior ‘lane change’ is 0.015. FIG. 6A shows an example of behavior estimation by the dedicated behavior estimation neural network. The example shown in FIG. 6A is a case where the environmental parameter set input is included in the travel records used for constructing dedicated behavior estimation NN.

In contrast, as shown in FIG. 6B, when the environmental parameter set typically including driver's vehicle speed Va and leading vehicle speed Vba is input to dedicated behavior estimation NN, behaviors, such as ‘deceleration’ and ‘lane change’ that are tentative behavior estimation results, may have different output probabilities. In FIG. 6B, for example, the output probability of the behavior ‘deceleration’ is 0.5 and the output probability of behavior ‘lane change’ is 0.015. FIG. 6B shows another example of behavior estimation by the dedicated behavior estimation neural network. The example shown in FIG. 6B is a case where the input environmental parameter set is not included in the travel records used for constructing dedicated behavior estimation NN.

Behavior estimator 14 selects a tentative behavior to be actually used for a behavior of vehicle 1 from the tentative behaviors. In other words, Behavior estimator 14 estimates a behavior. For example, behavior estimator 14 may select a tentative behavior with the highest output probability in the tentative behaviors. Behavior estimator 14 outputs the tentative behavior estimation result and the output probability corresponding to the tentative behavior estimation result to incorrectness risk determiner 101, in order to determine correctness, or an incorrectness risk, of the tentative behavior estimation result output from dedicated behavior estimation NN.

Still more, learner 13 may acquire a behavior determined by behavior estimator 14 from the tentative behaviors. Furthermore, learner 13 may learn again weights between nodes of dedicated behavior estimation NN using the behavior acquired as supervised data to update dedicated behavior estimation NN, in order to increase the matching rate of the output of dedicated behavior estimation NN and the supervised data.

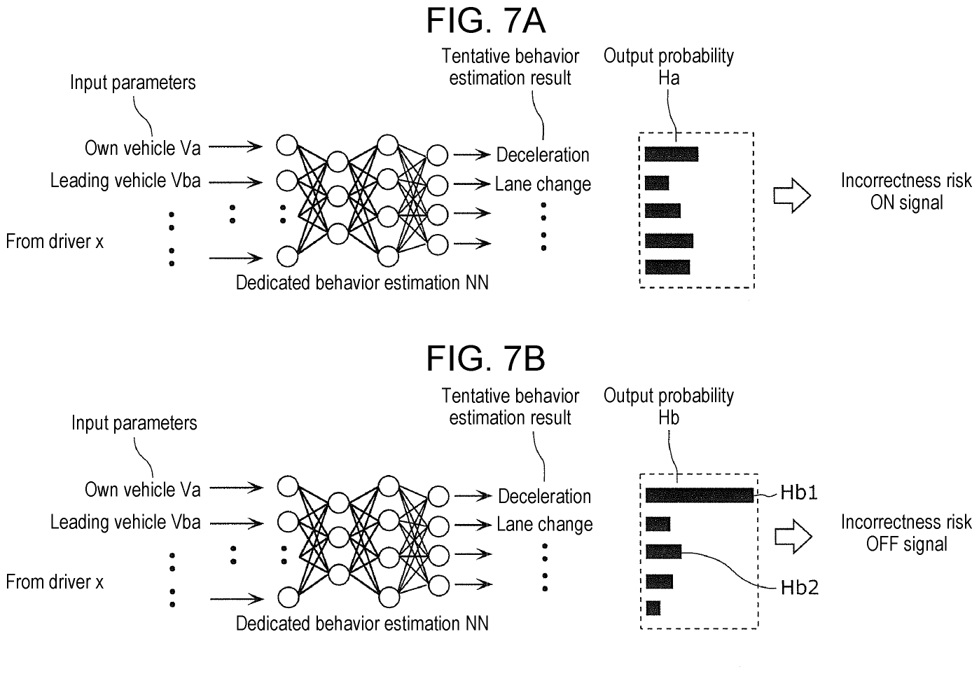

Incorrectness risk determiner 101 determines the presence of incorrectness risk in the tentative behavior estimation result on the basis of correctness of the tentative estimation result. More specifically, incorrectness risk determiner 101 determines that there is incorrectness risk when correctness of the tentative behavior estimation result is not greater than a threshold. At this time, incorrectness risk determiner 101 determines the incorrectness risk of the tentative behavior estimation result on the basis of the output probability of the tentative behavior received from behavior estimator 14. For example, in a case shown in FIG. 7A, incorrectness risk determiner 101 determines that the output probability carries incorrectness risk, i.e., the tentative behavior estimation result includes incorrectness risk. Incorrectness risk determiner 101 then outputs a signal for turning on the incorrectness risk to safety determiner 103. In a case shown in FIG. 7B, incorrectness risk determiner 101 determines that the output probability does not carry incorrectness risk, i.e., the tentative behavior estimation result does not include incorrectness risk. Incorrectness-risk determiner 101 then outputs a signal for turning off the incorrectness risk to safety determiner 103. When incorrectness risk determiner 101 outputs the signal for turning off the incorrectness risk, behavior estimator 14 determines a behavior to be performed by vehicle 1, using the tentative behavior output from dedicated behavior estimation NN and the output probability corresponding to the tentative behavior. Behavior estimator 14 outputs the determined behavior as an automated driving behavior signal to safety determiner 103. FIG. 7A and FIG. 7B shows examples of behavior estimation by the dedicated behavior estimation neural network.

Whether or not the output probability of tentative behavior carries incorrectness risk may be determined on the basis of a relative relation among all output probabilities (hereinafter also called ‘output probability set’) corresponding to tentative behaviors output from dedicated behavior estimation NN. A condition for determining that the output probability does not carry any incorrectness risk may be, for example, a large difference between highest output probability Hb1 and second highest output probability Hb2 in output probability set Hb, such as output probability set Hb shown in FIG. 7B. More specifically, the difference is, for example, that output probability Hb1 is more than twice output probability Hb2. In other words, output probability set Hb is determined to carry an incorrectness risk when output probability Hb1 is equal to or less than twice output probability Hb2. Alternatively, in the above condition, output probability Hb1 may be more than 75% of the sum of all output probabilities in output probability set Hb. In other words, output probability set Hb is determined to carry incorrectness risk when output probability Hb1 is equal to or less than 75% of the sum of all output probabilities in output probability set Hb. The two conditions may be applied in combination. Accordingly, incorrectness risk determiner 101 determines that there is incorrectness risk when the probability of the tentative behavior estimation result is equal to or less than the threshold.

Safety-and-comfort determiner 102 determines whether the travel state of vehicle 1 belongs to a safety range, a comfort range, or a hazard range. Safety-and-comfort determiner 102 uses travel state radar chart A stored in storage 12 for making this determination. In the present exemplary embodiment, same travel state radar chart A is used for all travel states of vehicle 1, but not limited thereto.

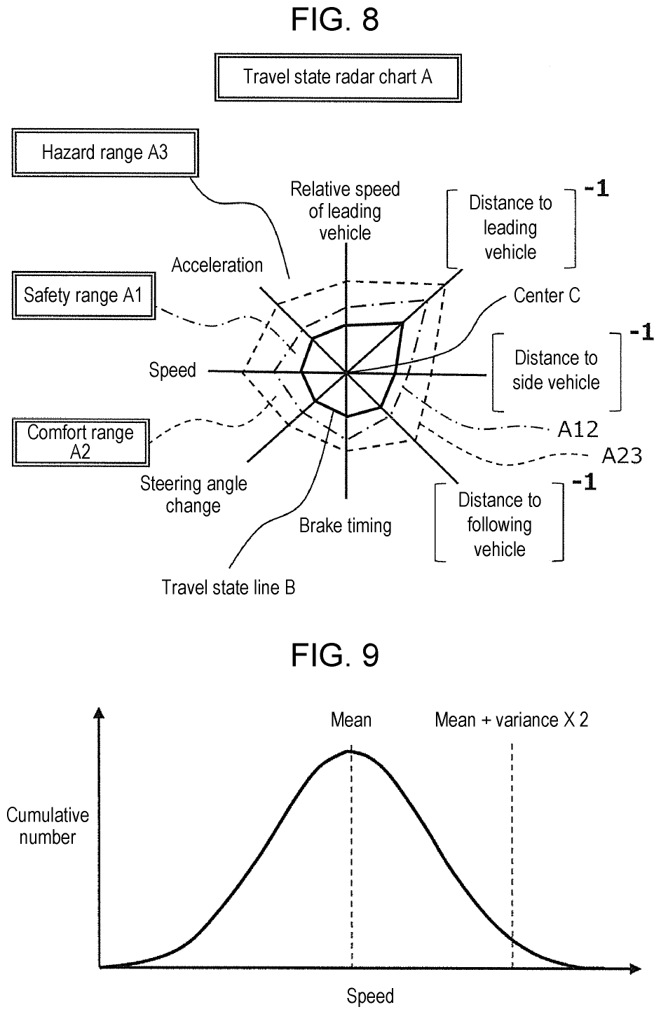

Now, travel state radar chart A is described with reference to FIG. 8. FIG. 8 shows an example of travel state radar chart A. Travel state radar chart A has axes for several items extending radially from center C. A value for each item in travel state radar chart A is the smallest at center C and increases in a radial direction outward along each item axis.

The items include those related to vehicle 1 and those related to vehicles around vehicle 1. The items related to vehicle 1 are also items related to features. The items related to the vehicles around vehicle 1 are also items related to environmental parameters. Although not limited, the items include an acceleration, a speed, a steering angle change, and a brake timing related to vehicle 1, and a relative speed of a leading vehicle, a distance to the leading vehicle, a distance to a side vehicle, and a distance to a following vehicle. The number of items is not limited to eight. It can be seven or less, and also nine or more.

‘Acceleration’ indicates acceleration applied to vehicle 1. ‘Speed’ indicates a travel speed of vehicle 1. ‘Steering angle change’ indicates a change in angle with respect to the straight direction of the steering wheel of vehicle 1. ‘Brake timing’ indicates an intensity (level) of the brake of vehicle 1. ‘Relative speed of the leading vehicle’ indicates a speed of a leading vehicle in front of vehicle 1 with respect to vehicle 1, and this value may be an absolute value of the relative speed. ‘Distance to the leading vehicle’ indicates a spatial distance between vehicle 1 and the leading vehicle. ‘Distance to the side vehicle’ indicates a spatial distance between vehicle 1 and a vehicle to the right or left of vehicle 1. ‘Distance to the following vehicle’ indicates a spatial distance between vehicle 1 and a following vehicle at the back of vehicle 1. In travel state radar chart A, a value of each item related to vehicle 1 increases and the safety decreases away from center C. Therefore, for values each of which increment results in enhancement of the safety, i.e., distance to the leading vehicle, distance to the side vehicle, and distance to the following vehicle; an inverse of each of the values is indicated in travel state radar chart A.

Still more, safety range A1, comfort range A2, and hazard range A3 are set in travel state radar chart A. Safety range A1 is set around center C including center C. Comfort range A2 is set around safety range A1 and borders an outer side of safety range A1 in the radial direction. Hazard range A3 is an area on the outer side of comfort range A2 in the radial direction. The travel state of vehicle 1 can be determined by plotting values for the items related to vehicle 1 in travel state radar chart A. For example, when all plotted dots are inside safety range A1, the travel state of vehicle 1 can be presumed to be safe. When all plotted dots are in comfort range A2, the travel state of vehicle 1 can be presumed comfortable for the occupants. When all plotted dots are in hazard range A3, it can be presumed that a danger lies in the travel state of vehicle 1. When the plotted dots exist across two or more ranges, a range where a dot closest to hazard range A3 is located can show the travel state of vehicle 1.

Positions of boundaries between safety range A1, comfort range A2, and hazard range A3 in travel state radar chart A may be set on the basis of drive records and travel records of a specific driver of vehicle 1, or set on the basis of drive records and travel records of multiple drivers. In the present exemplary embodiment, the drive records and the travel records of multiple drivers are used. This can generalize boundary positions without applying features peculiar to individual drivers. Boundary positions based on the drive records and the travel records of multiple drivers may be determined by machine learning or by a statistical method. In the present exemplary embodiment, a statistical method is adopted.

For example, a value for each item at boundary A12 between safety range A1 and comfort range A2 may be a mean value or a value near the statistical center, such as a center value and a most-frequent value, of values for each item in the drive records and the travel records of multiple drivers. This boundary A12 belongs to safety range A1 in the present exemplary embodiment, but it may belong to comfort range A2. For example, each item of the drive records and the travel records of many and unspecified drivers generally shows distribution close to normal distribution, as shown in FIG. 9. FIG. 9 is an example of vehicle speed distribution. The horizontal axis indicates driver's vehicle speed and the vertical axis indicates the cumulative number of detections of the driver's vehicle speed. When the mean value is a value at boundary A12, safety range A1 includes most of the bottom half of driver's vehicle speed records, and thus is a safety-oriented range. This is same for other items. Safety range A1 determined on the basis of this type of boundary A12 is a range oriented to safety.

A value for each item at boundary A23 between comfort range A2 and hazard range A3 may be a value such as ‘Mean value+Variance value×2’ of values for the items in the drive records and the travel records of multiple drivers. The above mean value may be replaced with a value close to the statistical center, such as a center value and a most-frequent value. This boundary A23 belongs to comfort range A2 in the present exemplary embodiment, but may also belong to hazard range A3. Comfort range A2 determined by this boundary A23 includes many values for the items of the drive records and the travel records of multiple drivers, as shown in an example in FIG. 9, and thus is a range oriented to comfortableness accepted by many drivers. Hazard range A3 includes part of the top values for each item of the drive records and the travel records of multiple drivers, and can include relatively extraordinary danger for many drivers.

As shown FIG. 1 and FIG. 8, safety-and-comfort determiner 102 acquires information on detection results of detector 11, and calculates a value corresponding to each item of travel state radar chart A on the basis of the acquired information. The value corresponding to each item of travel state radar chart A does not have to be a measured value. It can be a converted value easy for comparing numerical values for each item. The value corresponding to each item of travel state radar chart A shows the current state of vehicle 1. Safety-and-comfort determiner 102 plots the calculated values for the items in travel state radar chart A. Travel state line B indicating the travel state of vehicle 1 is formed by connecting the plotted dots with line segments.

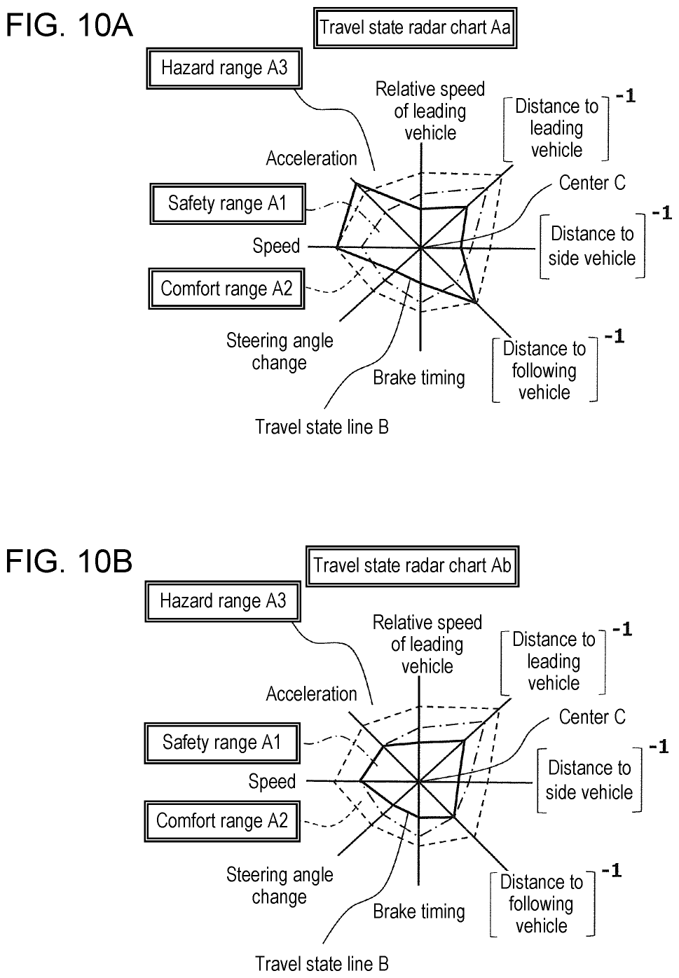

Safety-and-comfort determiner 102 plots values corresponding to the items in travel state radar chart A in real time while vehicle 1 travels, so as to form travel state radar chart Aa including the travel state of vehicle 1. FIG. 10A shows an example of travel state radar chart Aa indicating the real-time travel state of vehicle 1, and FIG. 10B shows travel state radar chart Ab in which the travel state of travel state radar chart Aa in FIG. 10A is changed to a safer state. As shown in FIG. 10A, when a value for at least one item falls under comfort range A2 or hazard range A3 in travel state radar chart Aa, safety-and-comfort determiner 102 changes the value for the items concerned to form travel state radar chart Ab so that values for all items fall under safety range A1. This adjusts travel state line B to be included in safety range A1, as shown by travel state radar chart Ab in FIG. 10B.

More specifically, when item values are to be changed, safety-and-comfort determiner 102 changes item values falling under comfort range A2 and hazard range A3 to values at boundary A12 between safety range A1 and comfort range A2, and retains item values in safety range A1. For changing item values, those in comfort range A2 and hazard range A3 may be changed to values inside boundary A12 of safety range A1. For example, in the examples shown in FIG. 10A and FIG. 10B, safety-and-comfort determiner 102 changes acceleration and speed of the driver's vehicle, and distance to the following vehicle. Safety-and-comfort determiner 102 determines a safe behavior for changing the current travel state of vehicle 1 shown in FIG. 10A to the travel state of vehicle 1 shown in FIG. 10B, and outputs a signal indicating the determined safe behavior to safety determiner 103 as a safe behavior signal. The safe behavior is a behavior to adjust the travel state of vehicle 1 to make parameter values indicating the current travel state of vehicle 1 fall under safety range A1.

Safety determiner 103 selects the automated driving behavior signal or the safe behavior signal according to ON or OFF of the incorrectness risk, and outputs the selected signal to vehicle controller 2. In other words, safety determiner 103 determines a driving operation to be performed by vehicle 1, and outputs this determination result to vehicle controller 2. More specifically, when safety determiner 103 receives from incorrectness risk determiner 101 an incorrectness risk OFF signal, safety determiner 103 selects the automated driving behavior signal received from behavior estimator 14, and outputs this signal to vehicle controller 2. Vehicle controller 2 thus controls vehicle 1 according to the automated driving behavior signal. When safety determiner 103 receives from incorrectness risk determiner 101 an incorrectness risk ON signal, safety determiner 103 selects the safe behavior signal, and outputs this signal to vehicle controller 2. Vehicle controller 2 thus controls vehicle 1 according to the safe behavior signal. The incorrectness risk OFF signal and incorrectness risk ON signal are also called incorrectness risk signals. In this way, when the automated driving behavior signal may lack correctness, vehicle controller 2 controls vehicle 1 in a way such that the travel state will fall under safety range A1 in travel state radar chart A. This prevents vehicle 1 from being controlled on the basis of information that may lack correctness or reliability.

[1-2. Operation of Information Processing System According to the First Exemplary Embodiment]

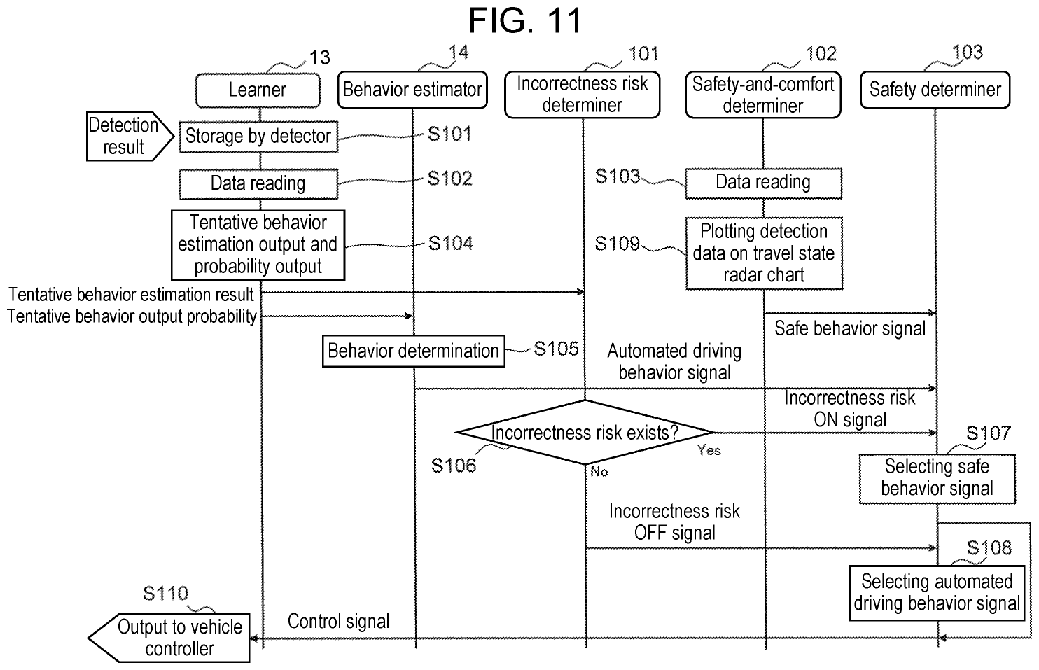

The operation of information processing system 100 and according to the first exemplary embodiment the peripheral components thereof is described with reference to FIG. 1 and FIG. 11. FIG. 11 is a sequence diagram of an example of a flow of operations in information processing system 100 and the peripheral components thereof.

In Step S101, detector 11 of automated driving control system 10 stores detection results related to vehicle 1 into storage 12 of automated driving control system 10. Then, in Step S102, learner 13 of automated driving control system 10 reads detection data of detector 11 and data of dedicated behavior estimation NN of specific driver x of vehicle 1.

Then, in Step S104, learner 13 inputs features and environmental parameter values in detection data to dedicated behavior estimation NN as input parameter values of driver x to output a tentative behavior estimation result. Still more, learner 13 outputs an output probability of each tentative behavior in the tentative behavior estimation result. Learner 13 outputs the tentative behavior estimation result and an output probability of each tentative behavior to behavior estimator 14 of automated driving control system 10 and incorrectness risk determiner 101 of information processing system 100. Processing in Steps S102 and 5104 may also be performed by behavior estimator 14.

In next Step S105, behavior estimator 14 selects a behavior to be performed by vehicle 1 from the tentative behavior estimation result, on the basis of the output probability of each tentative behavior, and outputs the selected behavior as the automated driving behavior signal to safety determiner 103 of information processing system 100.

In Step S106 in parallel with Step S105, incorrectness risk determiner 101 determines whether or not the tentative behavior estimation result carries an incorrectness risk, on the basis of the output probability of each tentative behavior. When the incorrectness risk exists (Yes in Step S106), incorrectness risk determiner 101 outputs an incorrectness risk ON signal to safety determiner 103. Safety determiner 103 then executes processing in Step A107. When the incorrectness risk does not exist (No in Step 5106), incorrectness risk determiner 101 outputs an incorrectness risk OFF signal to safety determiner 103, and safety determiner 103 executes processing in Step S108.

In Step S103 in parallel with Step S102, safety-and-comfort determiner 102 in information processing system 100 reads the detection data of detector 11 and travel state radar chart A from storage 12. The detection data read out in Step S103 is data detected at the same time as the detection data read out in Step S102. In Step S109, safety-and-comfort determiner 102 plots features and environmental parameter values in the detection data on travel state radar chart A. When all plotted dots fall under safety range Al in travel state radar chart A, safety-and-comfort determiner 102 determines a behavior for retaining the travel state indicated in travel state radar chart A as a safe behavior, and this safe behavior is output to safety determiner 103 as the safe behavior signal. When some plotted dots fall under comfort range A2 or hazard range A3, safety-and-comfort determiner 102 changes travel state line B in travel state radar chart A such that dots concerned come within safety range A1, determines a behavior for changing the travel state of travel state line B before change to that after change as the safe behavior, and outputs this safe behavior to safety determiner 103 as the safe behavior signal.

Before Step S107, safety determiner 103 receives the automated driving behavior signal, the incorrectness risk ON signal, and the safe behavior signal. Since the tentative behavior estimation result carries the incorrectness risk, safety determiner 103 selects the safe behavior signal as a signal for appropriate behavior of vehicle 1 from the automated driving behavior signal and the safe behavior signal, and outputs the safe behavior signal to vehicle controller 2. Still more, safety determiner 103 relates the safe behavior indicated by the safe behavior signal to the features and the environmental parameter values input to dedicated behavior estimation NN in Step S104, and stores it into storage 12. This enables to associate the aforementioned features and the environmental parameter values corresponding to the detection data of detector 11 with actual behavior executed by vehicle 1.

Mutually associated features and environmental parameter values and the behavior of vehicle 1 may be used as machine learning data for behavior estimation, as a new drive record and a new travel record of driver x. These new drive record and travel record of driver x may be added to the existing drive records and the existing travel records of driver x to update these pieces of data. Alternatively, they may be added to the existing drive records and travel records of multiple drivers to update these pieces of data. Storage and update of the drive-record and the travel-record data of driver x and those of multiple drivers may take place in storage 12, or in a server device located away from vehicle 1. The server device may be a computer device or a cloud server using a communication network such as the Internet. In this case, for example, driver x upload the new drive record and the new travel record of driver x to the server device to update the drive-record and the travel-record data in the server device after driver x has been home. The data of the drive-record and the travel-record in the server device is also updated by the drive records and the travel records of other drivers. Driver x may download, from the server device, the data of the drive-record and the travel-record updated by various drivers' drive records and travel records and store them into storage 12. This achieves automated driving using machine learning data with further learning experiences.

The server device may construct behavior estimation NN and perform learning, instead of learner 13. For example, the server device may use data stored in the server device to adjust weights between nodes in general behavior estimation NN and dedicated behavior estimation NN. Then, learner 13 or behavior estimator 14 downloads, from the server device, the data in which weights are adjusted by the server device.

Before Step S108, safety determiner 103 receives the automated driving behavior signal, incorrectness risk OFF signal, and safe behavior signal. Since the tentative behavior estimation result carries no incorrectness risk, safety determiner 103 selects the automated driving behavior signal as a signal for appropriate behavior of vehicle 1 from the automated driving behavior signal and the safe behavior signal, and outputs the automated driving behavior signal to vehicle controller 2. Safety determiner 103 also relates an estimated behavior indicated by the automated driving behavior signal to corresponding features and environmental parameters, and store it into storage 12. This associates the detection data of detector 11 with a behavior performed by vehicle 1. In Step S110 following Steps S107 and S108, vehicle controller 2 controls the behavior of vehicle 1 on the basis of the received automated driving behavior signal or the safe behavior signal. For example, as a result of controlling the behavior of vehicle 1 by vehicle controller 2 according to the safe behavior signal, vehicle 1 travels in the travel state within safety range A1 of travel state radar chart A.

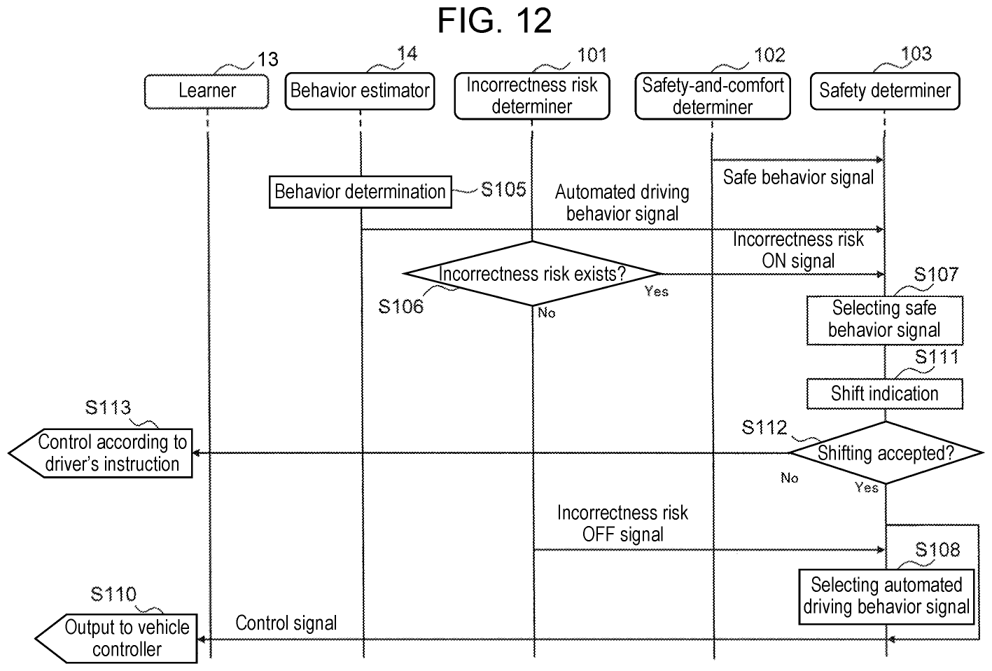

Meanwhile, as shown in FIG. 12, another processing may be provided between Step S107 and Step S110. FIG. 12 is a sequence diagram of another example of a flow of operations in information processing system 100 and the peripheral components thereof.

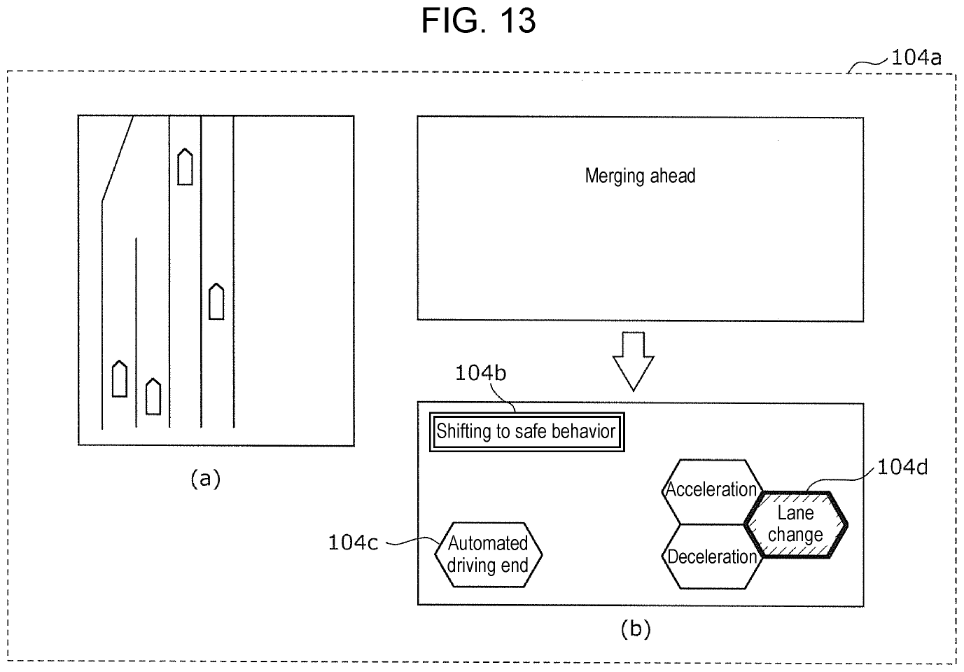

More specifically, in Step S107, safety determiner 103 selects the safe behavior signal as a signal for appropriate behavior of vehicle 1, and outputs a signal to report adoption of the safe behavior to information reporter 104 in information processing system 100. Then, in Step S111, information reporter 104 displays shift indication 104b indicating shifting to the safe behavior in automated driving on a display screen of display device 104a of vehicle 1, for example, as shown in FIG. 13. FIG. 13 shows an example of indication for shifting to the safe behavior on display device 104a in information processing system 100. Display device 104a may be an UI (User Interface) display, such as a head up display (HUD), a liquid crystal display (LCD), an organic or inorganic electro luminescence (EL) display, a head-mounted display or a helmet-mounted display (HMD), smart glasses, and other dedicated displays. The HUD may, for example, have a structure of using a wind shield of vehicle 1, or a glass surface or plastic surface (e.g., combiner) provided other than the wind shield. Still more, the wind shield may be a front glass, side glass, or rear glass of vehicle 1.

Safety determiner 103 asks driver x of vehicle 1 whether to shift to the safe behavior by making information reporter 104 display shift indication 104b (Step S112). More specifically, automated driving control system 10 displays, on the display screen of display device 104a, manual driving icon 104c for making decision to terminate automated driving and behavior selecting icon 104d that provides selectable behaviors. Behavior selecting icon 104d includes, for example, several icons for selecting behaviors such as acceleration, deceleration, and lane change. Information reporter 104 uses these icons to ask whether to shift to the safe behavior. When driver x of vehicle 1 touches one of the icons with a finger or select using an input device such as a switch (No in Step S112), automated driving control system 10 performs control according to the icon selected by driver x and shifting to the safe behavior is stopped (Step S113). For example, when driver x touches or selects manual driving icon 104c, automated driving control system 10 switches from automated driving to manual driving. When driver x touches or selects an icon for acceleration, deceleration, or lane change, automated driving control system 10 executes control for acceleration, deceleration, or lane change. When driver x of vehicle 1 does not touch or select manual driving icon 104c or behavior selecting icon 104d for a predetermined time (Yes in Step S112), safety determiner 103 outputs the safe behavior signal to vehicle controller 2 as a signal for appropriate behavior of vehicle 1 (Step S110).

Safety determiner 103 may acquire a selection result of driver x after displaying shift indication 104b, associate the selection result with the features and environmental parameter values input to dedicated behavior estimation NN in Step S104, and store the selection result into storage 12 in the course of generating the safe behavior signal. This enables to associate the above features and the environmental parameter values corresponding to the detection data of detector 11 with an actual behavior performed by vehicle 1. The mutually associated features, the environmental parameter values, and the behavior of vehicle 1 may be used for machine learning data of behavior estimation as a new drive record and a new travel record of driver x. The new drive record and the new travel record of driver x may be added to the existing data of drive-record and travel-record of driver x to update these pieces of data. Or, the new drive record and the new drive travel record may be added to the existing data of drive-record and travel-record of multiple drivers to update these pieces of data. The data of drive-record and travel-record of driver x and that of other multiple drivers may be stored and updated in storage 12 or in a server device located away from vehicle 1.

An above-described case where safety determiner 103 selects the safe behavior signal in processing in Step S107, is described with reference to FIG. 10A and FIG. 10B. An incorrectness risk highly occurs when a travel state that is not included or scarcely included in the drive records and the travel records of driver x and those of many and unspecified drivers of vehicle 1 occurs during automated driving of vehicle 1. The example of travel state radar chart Aa in FIG. 10A shows the travel state that the speed of vehicle 1 is increasing but a distance to the following vehicle is reducing. Such a travel state scarcely occurs in normal traveling and thus output probabilities of tentative behaviors acquired by inputting the features and the environmental parameters corresponding to this travel state to dedicated behavior estimation NN do not include any combination of output probabilities of tentative behaviors that can determine one specific tentative behavior, and thus the incorrectness risk may exist. In this case, safety determiner 103 adopts a safe behavior signal to change the travel state to that indicated in travel state radar chart Ab in FIG. 10B.

[1-3. Effects]

As described above, information processing system 100 according to the first exemplary embodiment includes incorrectness risk determiner 101, safety-and-comfort determiner 102 as a safe behavior determiner, and safety determiner 103. Incorrectness risk determiner 101 acquires a behavior estimation result of vehicle 1, and determines whether the behavior estimation result carries an incorrectness risk. Safety-and-comfort determiner 102 classifies parameter values indicating the travel state of vehicle 1 into multiple ranges A1, A2, and A3 on the basis of travel safety. Safety-and-comfort determiner 102 determines the safe behavior for vehicle 1, and this safe behavior adjusts the travel state of vehicle 1 so that the parameter values indicating the travel state of vehicle 1 fall under safety range A1 that is a range with the highest travel safety of ranges A1, A2, and A3. Safety determiner 103 determines a behavior control of vehicle 1 according to a determination result of incorrectness risk determiner 101. Safety determiner 103 selects the safe behavior determined by safety-and-comfort determiner 102 when acquiring a determination carrying incorrectness risk from incorrectness risk determiner 101. When safety determiner 103 acquires a determination carrying no incorrectness risk from incorrectness risk determiner 101, safety determiner 103 selects the behavior estimation result.

In the above configuration, the behavior estimation result of vehicle 1 carrying incorrectness risk is not used for the behavior control of vehicle 1. Instead, the safe behavior that will adjust the travel state to within safety range A1 with high travel safety is used for the behavior control of vehicle 1. The use of a safe behavior for control enables a safe behavior for vehicle 1. This reduces an uncertain behavior of vehicle 1 due to the incorrectness risk. Accordingly, the incorrectness risk included in the vehicle behavior estimation carrying can be reduced. Reduction of incorrectness risk includes avoidance of incorrectness risk in addition to reduction of incorrectness risk.

In information processing system 100 according to the first exemplary embodiment, incorrectness risk determiner 101 determines that the behavior estimation result carries an incorrectness risk when correctness of the behavior estimation result is equal to or less than a threshold. In the above configuration, incorrectness risk determiner 101 determines that the behavior estimation result carries an incorrectness risk when correctness of the behavior estimation result is low. This suppresses automated driving based on the behavior estimation result with low correctness.

In information processing system 100 according to the first exemplary embodiment, the behavior estimation result is a result estimated, using machine learning, from at least information on surroundings of vehicle 1 and information on the travel state of vehicle 1. In the above configuration, a behavior estimated using the machine learning is based on the driver's experience, and can thus be close to driver's predictable behavior. In other words, a behavior estimated using the machine learning can be close to driver's feeling. The machine learning may be, for example, a neural network.

In information processing system 100 according to the first exemplary embodiment, incorrectness risk determiner 101 makes determination based on output probabilities of multiple behaviors included in the behavior estimation result. In the above configuration, when the behavior estimation result includes multiple behaviors, smaller the difference between output probabilities of behaviors, for example, larger the uncertainty of correctness of the behaviors. When a difference between output probabilities of behaviors is large and one behavior shows high output probability, the correctness probability of this behavior is high. Accordingly, whether or not the behavior estimation result carries the incorrectness risk can be easily determined by using behavior output probabilities.

Information processing system 100 according to the first exemplary embodiment further includes information reporter 104 configured to provide the determination result of safety determiner 103 to the driver of vehicle 1. For example, information reporter 104 may provide the result via display device 104a. In the above configuration, the driver can confirm that the automated driving control of vehicle 1 is shifting to a control based on the safe behavior. For example, when the driver cannot accept the shift, automated driving can be switched to manual driving.

Information processing system 100 according to the first exemplary embodiment further includes a receiver configured to receive acceptance or rejection of the determination result of safety determiner 103 by the driver of vehicle 1. The receiver may be, for example, manual driving icon 104c and behavior selecting icon 104d on display device 104a. In the above configuration, the driver operates manual driving icon 104c or behavior selecting icon 104d to change automated driving of vehicle 1 when the driver cannot accept the determination result of safety determiner 103.

The information processing method according to the first exemplary embodiment may be achieved through the following method. In this information processing method, a behavior estimation result of a vehicle is acquired. Then, whether or not the behavior estimation result carries an incorrectness risk is determined. Still more, parameter values indicating a travel state of the vehicle are acquired and these parameter values are classified into multiple ranges based on travel safety. Then, a safe behavior for the vehicle is determined. The safe behavior adjusts the travel state of the vehicle such that these parameter values fall under a range with high travel safety in the multiple ranges. When the incorrectness risk exists in the determination result, the safe behavior is selected. When the incorrectness risk does not exist in the determination result, the behavior estimation result is selected.

The above method may be achieved by employing circuitry, such as an MPU (Micro Processing Unit), a CPU, processor, and an LSI; an IC card, or single module.

Processing according to the first exemplary embodiment may be achieved by a software program or digital signals consisted of software program. For example, the processing according to the first exemplary embodiment may be achieved by employing the following program. More specifically, this program makes a computer execute the following steps. 1) Acquire a behavior estimation result of a vehicle. 2) Determine whether or not the behavior estimation result carries an incorrectness risk. 3) Acquire parameter values indicating a travel state of the vehicle. 4) Classify the parameter values into multiple ranges based on travel safety. 5) Determine a safe behavior for the vehicle by which the travel state of the vehicle is adjusted such that the parameter values fall under a range with high travel safety of the multiple ranges. 6) Select the safe behavior when the determination result indicates that the incorrectness risk exists, and select the behavior estimation result when the determination result indicates that no incorrectness risk exists.

The above program and the digital signals consisted of the program may be recorded in a computer-readable recoding medium, such as a flexible disk, hard disk, CD-ROM, MO, DVD, DVD-ROM, DVD-RAM, BD (Blu-ray (registered trademark) disk), and semiconductor memory.

Still more, the program and the digital signals consisted of the program may be sent via an electric communication line, a wireless or wired communication line, a network, typically the Internet, or data broadcast. The program and the digital signals consisted of the program may also be executed by other independent computer systems by recording and transferring the program via a recording medium or by transferring the program typically via a network.

### Second Exemplary Embodiment

[2-1. Information Processing System According to Second Exemplary Embodiment]

Information processing system 200 according to a second exemplary embodiment is described. Information processing system 100 according to the first exemplary embodiment uses a preset travel state radar chart as it is. However, information processing system 200 according to the second exemplary embodiment uses a travel state radar chart that changes each range according to the external environment of vehicle 1. The differences with respect to the first exemplary embodiment are mainly described below.

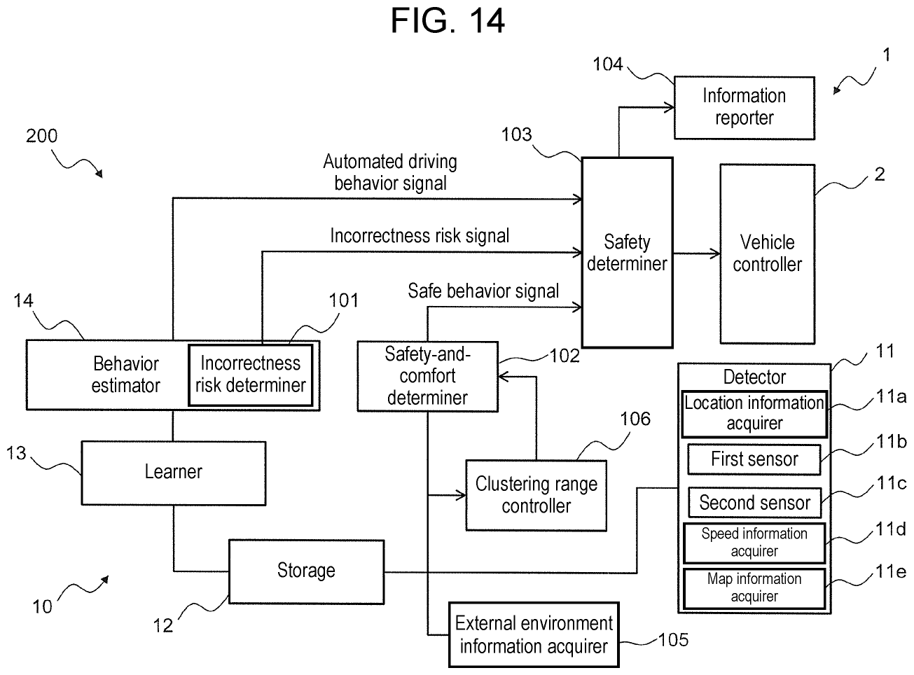

FIG. 14 shows an example of a functional block diagram of information processing system 200 according to the second exemplary embodiment and peripheral components thereof. Information processing system 200 includes external environment information acquirer 105 and clustering range controller 106, in addition to incorrectness risk determiner 101, safety-and-comfort determiner 102, safety determiner 103, and information reporter 104.

External environment information acquirer 105 acquires external environment information on surroundings of vehicle 1. The external environment information includes traffic congestion information, weather information, and accident record information of the road on which vehicle 1 travels. External environment information acquirer 105 acquires the traffic congestion information using, for example, VICS (registered trademark) (Vehicle Information and Communication System), and the weather information and the accident record information using communication via a communication network, such as the Internet. External environmental information acquirer 105 stores acquired external environment information into storage 12.

Clustering range controller 106 changes the safety range, the comfort range, and the hazard range that are clustered ranges of the travel state radar chart, according to various pieces of information including external environment information. Storage 12 stores preset travel state radar chart. The safety range, the comfort range, and the hazard range are preset in this travel state radar chart. In other words, the travel state radar chart includes a default safety range, a default comfort range, and a default hazard range. This travel state radar chart is called a reference travel state radar chart in subsequent description. The safety range, the comfort range, and the hazard range of the reference travel state radar chart may be determined on the basis of the drive records and the travel records of many and unspecified drivers, as described in the first exemplary embodiment. Clustering range controller 106 acquires the reference travel state radar chart from storage 12, changes each range of the reference travel state radar chart as required, and outputs the changed chart to safety-and-comfort determiner 102. Safety-and-comfort determiner 102 determines the travel state of vehicle 1 on the basis of the changed travel state radar chart.

In the exemplary embodiment, clustering range controller 106 changes each range of the reference travel state radar chart according to information on a road on which vehicle 1 travels, information on a travel environment of vehicle 1, and information on travel experience of the road by vehicle 1. The above road information, travel environment information, and travel experience information are included in the external environment of vehicle 1.

The information on the road on which vehicle 1 travels includes the number of road lanes, a road type, a speed limit of the road, and accident record on the road. Clustering range controller 106 may, for example, acquire the number of lanes, road type, and speed limit via the location information by location information acquirer 11a and map information by map information acquirer 11e in detector 11. The road type may be related to road structures, such as a general road, a limited highway, and an express highway; or related to a road environment, such as a community road, an urban road, a suburban road, and a mountain road. Clustering range controller 106 acquires road accident records via external environment information acquirer 105, but the road accident records may be included in the map information of map information acquirer 11e. External environment information acquirer 105 may acquire the road accident records by using the location information of location information acquirer 11a and the map information of map information acquirer 11e.

The travel environment information of vehicle 1 includes the traffic congestion information and the weather information of the road on which vehicle 1 travels. Clustering range controller 106 acquires the traffic congestion information and the weather information via external environment information acquirer 105. External environment information acquirer 105 may acquire the traffic congestion information and the weather information on a route that vehicle 1 is scheduled to travel, using the location information of location information acquirer 11a and the map information of map information acquirer 11e.

Information on road travel experience by vehicle 1 may include the total number of travels and travel frequency of the road on which vehicle 1 travels. The travel frequency is the number of travels per a predetermined period. Clustering range controller 106 may acquire the information on travel experience, using travel records of the driver of vehicle 1 stored in storage 12, the location information of location information acquirer 11a, and the map information of map information acquirer 11e. Information whether the road on which vehicle 1 travels is a new or everyday road for the driver can be acquired from the travel experience information.

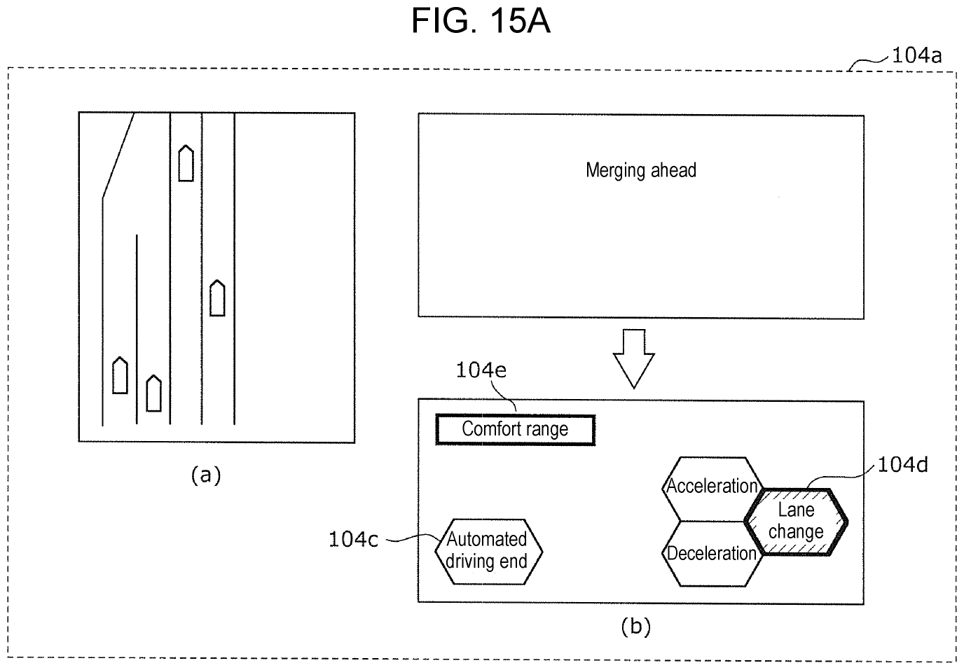

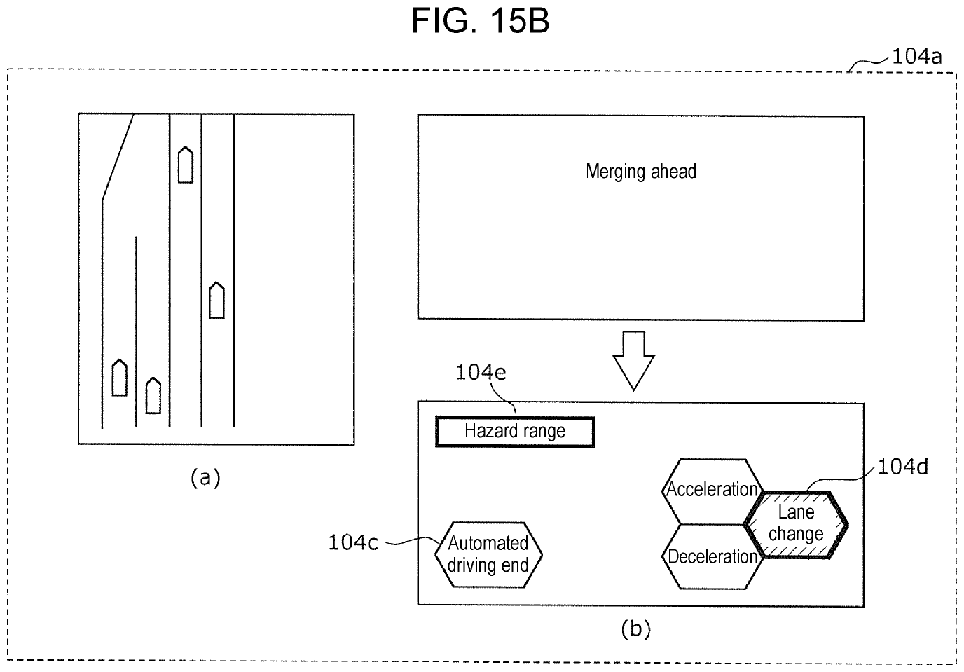

In the present exemplary embodiment, information reporter 104 displays whether the travel state of vehicle 1 belongs to, for example, the safety range, the comfort range, or the hazard range in the travel state radar chart on a display screen of display device 104a of vehicle 1, as shown in FIG. 15A and FIG. 15B. FIG. 15A shows an example in which the display screen of display device 104a shows the travel state in the comfort range. FIG. 15B shows an example in which the display screen of display device 104a shows the travel state in the hazard range. When the travel state display part 104e in the display screen of display device 104a displays ‘comfort range’ indicating that the travel state is in the comfort range, as shown in FIG. 15A, the driver of vehicle 1 can determine the next behavior of vehicle 1 with reference to this displayed information. For example, behavior selecting icon 104d that allows selection of behaviors is displayed on the display screen of display device 104a. Behavior selecting icon 104d includes multiple icons for selecting a behavior from, for example, acceleration, deceleration, and lane change. The driver can determine a behavior of vehicle 1 using behavior selecting icon 104d with reference to the displayed information in travel state display part 104e. When travel state display part 104e of display device 104a displays ‘hazard range’ indicating that the travel state is in the hazard range, as shown in FIG. 15B, the driver can select a subsequent behavior of vehicle 1, such as switching from automated driving to manual driving with reference to this displayed information. The driver selects manual driving icon 104c to apply this switchover.

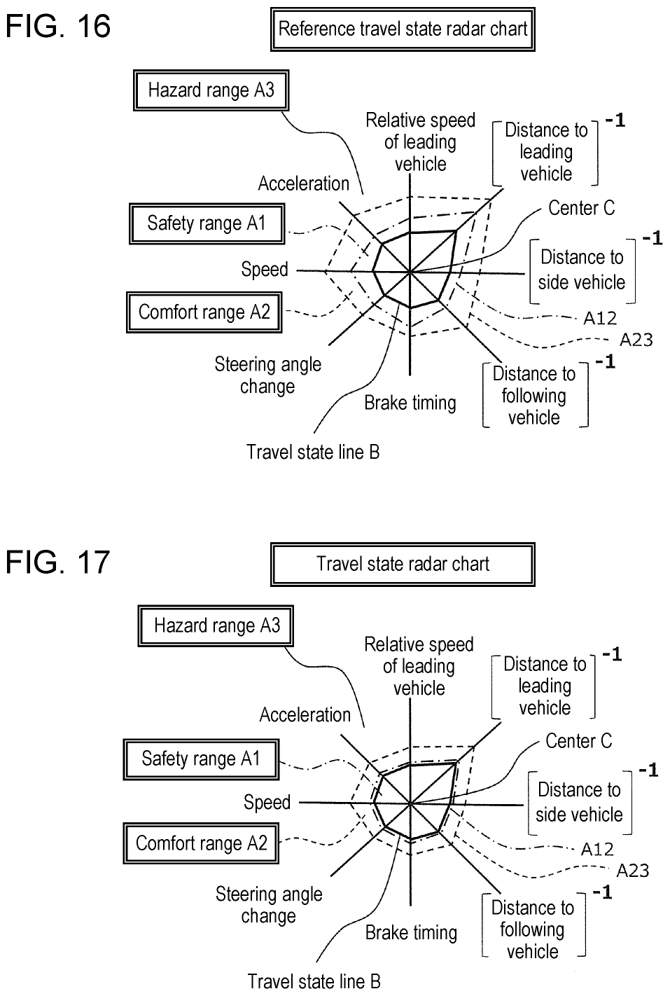

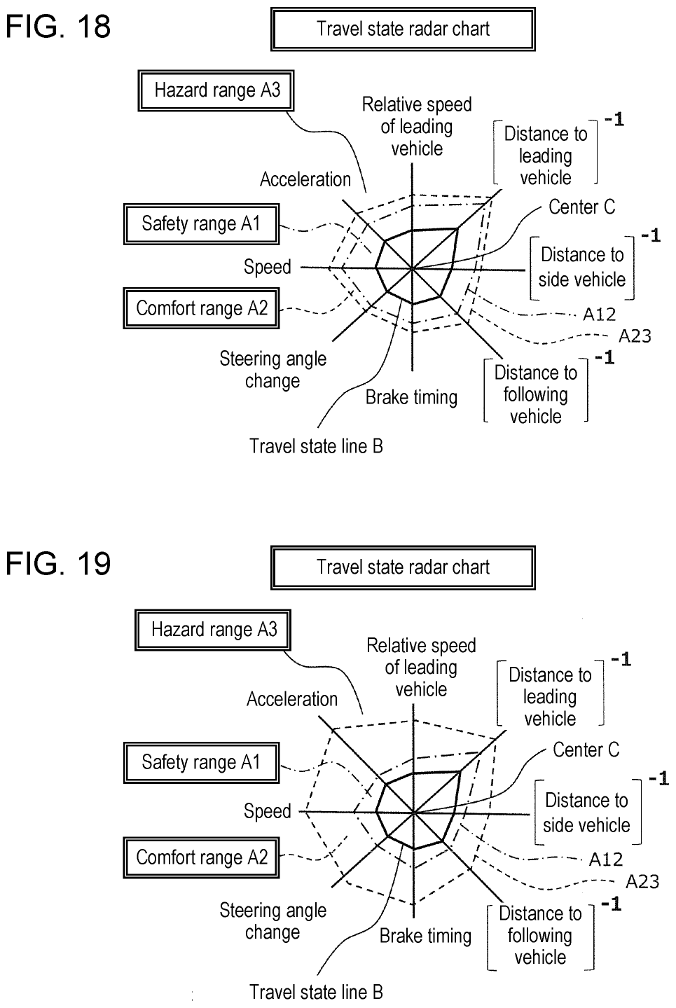

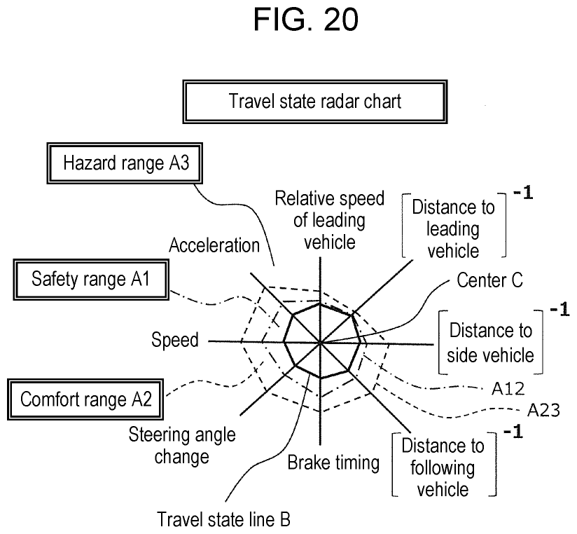

Next, an example of changing the reference travel radar chart by clustering range controller 106 is described with reference to FIG. 16 to FIG. 20. FIG. 16 shows an example of the reference travel state radar chart. FIG. 17 shows an example of a travel state radar chart in a case where there is an accident record on the road on which vehicle 1 travels. FIG. 18 shows an example of a travel state radar chart in a case where traffic is heavy on the road on which vehicle 1 travels. FIG. 19 shows an example of a travel state radar chart in a case where traffic is light and the weather is sunny on the road on which vehicle 1 travels. FIG. 20 shows an example of a travel state radar chart in a case where vehicle 1 routinely travels on the road on which vehicle 1 travels.

When an accident record exists in the road on which vehicle 1 travels, clustering range controller 106 reduces overall safety range A1 and comfort range A2 in the reference travel state radar chart in FIG. 16 to create the travel state radar chart shown in FIG. 17. More specifically, clustering range controller 106 moves overall boundary A12 of safety range A1 toward center C, and also moves overall boundary A23 of comfort range A2 toward center C. Safety-and-comfort determiner 102 determines the travel state of vehicle 1 from the safer view on generating the safe behavior signal to increase a frequency of changing travel state line B according to the travel state of vehicle 1, by using the travel state radar chart in FIG. 17.

When vehicle 1 is traveling on a main road with heavy traffic, clustering range controller 106 expands overall safety range A1 in the reference travel state radar chart in FIG. 16 to generate the travel state radar chart in FIG. 18. More specifically, clustering range controller 106 moves overall boundary A12 of safety range A1 in a direction away from center C. The travel state radar chart in FIG. 18 is based on a road traffic recognition that vehicle 1 is safe when vehicle 1 is traveling synchronously with surrounding vehicles. Safety-and-comfort determiner 102 reduces a frequency of changing travel state line B according to the travel state of vehicle 1 on generating the safe behavior signal, by using the travel state radar chart in FIG. 18.

When a road on which vehicle 1 travels has low traffic and the weather is fine, clustering range controller 106 expands overall comfort range A2 in the reference travel state radar chart in FIG. 16 to generate the travel state radar chart in FIG. 19. Comfort range A2 in the travel state radar chart in FIG. 19 is significantly larger than that in the reference travel state radar chart. More specifically, clustering range controller 106 increases parameter values related to the driver's vehicle in a proportion larger than parameter values related to surrounding vehicles at boundary A23 of comfort range A2. The travel state radar chart in FIG. 19 conforms to comfortable traveling suited to driver's characteristics.

When vehicle 1 is traveling on a road routinely used, clustering range controller 106 partially decreases safety range A1 in the reference travel state radar chart in FIG. 16 and partially decreases and increases comfort range A2 to generate a travel state radar chart in FIG. 20. More specifically, clustering range controller 106 reduces parameter values related to a leading vehicle at boundary A12 of safety range A1. Clustering range controller 106 decreases parameter values related to the leading vehicle and increases other parameter values at boundary A23 of comfort range A2. In the travel state radar chart in FIG. 20, comfort range A2 is expanded while relation with the leading vehicle is given importance on a road with which the driver is familiar. Safety-and-comfort determiner 102 increases a frequency of changing travel state line B according to the travel state of vehicle 1 on generating the safe behavior signal by using the travel state radar chart in FIG. 20.

In the above example, clustering range controller 106 changes each range of the reference travel state radar chart according to the information on the road on which vehicle 1 travels, the information on the travel environment of vehicle 1, and the information on the road travel experience by vehicle 1, but not limited thereto. For example, each range of the reference travel state radar chart may be changed according to the drive records and the travel records of a specific driver of vehicle 1. This enables to configure a range structure matching each driver's characteristics in the changed travel state radar chart. Accordingly, the driver is more likely to accept automated driving of vehicle 1 according to the safe behavior signal based on the travel state radar chart.

[2-2. Effects]

As described above, information processing system 200 according to the second exemplary embodiment includes safety-and-comfort determiner 102 as a safe behavior determiner, clustering range controller 106, and safety determiner 103. Safety-and-comfort determiner 102 classifies parameter values indicating the travel state of vehicle 1 into multiple ranges A1 to A3 based on travel safety. Safety-and-comfort determiner 102 determines a safe behavior of vehicle 1. The safe behavior adjusts the travel state of vehicle 1 such that parameter values indicating the travel state of vehicle 1 fall under safety range A1 with high travel safety of ranges A1 to A3. Clustering range controller 106 changes positions of boundaries between ranges A1 to A3 according to the external environment of vehicle 1. Safety determiner 103 acquires an estimation result of a behavior of vehicle 1 and the safe behavior determined by safety-and-comfort determiner 102, and determines behavior control of vehicle 1 on the basis of acquired behavior estimation result and the safe behavior.

In the above configuration, ranges A1 to A3 form ranges corresponding to the external environment of vehicle 1, and are changed so as to correspond to a change in the external environment of vehicle 1. The behavior control of vehicle 1 based on the safe behavior for making the travel state fall under safety range A1 with high travel safety can correspond to the external environment of vehicle 1 while ensuring safe behavior for vehicle 1. This reduces the behavior control of vehicle 1 deviated from the external environment of vehicle 1. Accordingly, a behavior that vehicle 1 should take can be accurately estimated.

Information processing system 200 according to the second exemplary embodiment further includes information reporter 104 configured to provide information on a range, of ranges A1 to A3, to which the travel state of vehicle 1 concerns to a driver of vehicle 1. For example, information reporter 104 may provide information via display device 104a. In the above configuration, the driver can confirm the current driving state of vehicle 1. For example, the driver can change the driving state of vehicle 1 according to the current driving state.

In information processing system 200 according to the second exemplary embodiment, the external environment includes at least road information on a road on which vehicle 1 travels, travel environment information of vehicle 1, and travel experience information on a road on which vehicle 1 travels. In the above configuration, the above information can contain various pieces of information on surroundings of vehicle 1. Accordingly, ranges A1 to A3 can be changed minutely corresponding to the environment around vehicle 1.

Information processing system 200 according to the second exemplary embodiment further includes incorrectness risk determiner 101 configured to determine whether or not the behavior estimation result carries an incorrectness risk. Incorrectness risk determiner 101 determines that the behavior estimation result carries the incorrectness risk when correctness of the behavior estimation result is equal to or less than a threshold. Safety determiner 103 then selects the behavior estimation result or the safe behavior on the basis of the determination result of incorrectness risk determiner 101. In the above configuration, information processing system 200 according to the second exemplary embodiment can achieve the effects same as information processing system 100 according to the first exemplary embodiment.

In information processing system 200 according to the second exemplary embodiment, the behavior estimation result is a result estimated from at least one of information on surroundings of vehicle 1 and information on the travel state of vehicle 1, using machine learning. In the above configuration, information processing system 200 according to the second exemplary embodiment can achieve the effects same as information processing system 100 according to the first exemplary embodiment.

Still more, an information processing method according to the second exemplary embodiment may be embodied in the following way. Specifically, in this information processing method, parameter values indicating a travel state of a vehicle are acquired, and these parameter values are classified into multiple ranges based on travel safety. A position of a boundary between the ranges is changed according to external environment of the vehicle. Still more, a safe behavior of the vehicle is determined. The safe behavior adjusts the travel state of the vehicle such that the parameter values fall under a range with high travel safety of the multiple ranges. A behavior estimation result of the vehicle is then acquired, a vehicle behavior control is determined on the basis of at least one of the behavior estimation result and the safe behavior.

Still more, processing according to the second exemplary embodiment may be achieved by a software program or digital signals consisting of software program. For example, processing according to the second exemplary embodiment is achieved by a following program. More specifically, this program makes a computer execute the following steps. 1) Acquire parameter values indicating a travel state of a vehicle. 2) Classify the parameter values into multiple ranges based on travel safety. 3) Change a position of the boundary between the ranges according to external environment of the vehicle. 4) Determine a safe behavior of the vehicle for adjusting the travel state of the vehicle such that the parameter values fall under a range with high safety of the multiple ranges. 5) Acquire an estimation result of the behavior of the vehicle, and determine a behavior control of the vehicle on the basis of at least one of the estimation result and the safe behavior.

[Others]

The exemplary embodiments are described above as examples of the technology in the present disclosure. However, the technology in the present disclosure is not limited to the exemplary embodiments. Modifications, including any change, replacement, addition, and omission to the exemplary embodiments as required and other exemplary embodiments are also applicable. Moreover, components described in the exemplary embodiments may be combined to form a new exemplary embodiment or variation.

Information processing systems 100 and 200 according to the first and second exemplary embodiments determine the behavior indicated by the safe behavior signal as a behavior to be performed by vehicle 1 when the estimation result of the behavior of vehicle 1 carries an incorrectness risk. Accordingly, the incorrectness risk in the behavior to be performed by vehicle 1 is reduced. However, processing in the information processing system is not limited thereto. For example, the information processing system may switch driving of vehicle 1 from automated driving to manual driving when the estimation result of the behavior for vehicle 1 carries an incorrectness risk. Or, an indication to prompt the driver of vehicle 1 to switch from automated driving to manual driving may be displayed on display device 104a. In this way, the information processing system can also avoid the incorrectness risk in the behavior of vehicle 1.

Each processing functional component in the information processing system according to the exemplary embodiments is typically achieved by an LSI as an integrated circuit. They may be individually made into one chip or partially or integrally made into one chip. Still more, the circuit integration is not limited to LSI. A dedicated circuit or a general-purpose processor may be used for the circuit integration. A FPGA (Field Programmable Gate Array) that can be programmed after fabricating LSI or a reconfigurable processor in which connections or settings of circuit cells inside LSI can be reconfigured may be used.

In the exemplary embodiments, each component is configured with dedicated hardware or achieved by running a software program suited for each component. Still more, each component may be achieved by reading and executing the software program recorded in a recording medium, such as a hard disk and a semiconductor memory, by a program executing unit such as a CPU and a processor.

Still more, the technology in the present disclosure may be the above program or a non-transitory computer-readable recording medium in which the above program is recorded. It is needless to say that the program can also be distributed via a transmission medium such as the Internet.

Numbers used in the above description, such as ordinal numbers and quantity, are all examples for specifically describing the technology in the present disclosure, and thus exemplified numbers do not restrict the present disclosure in any way. Connections between the components are also examples for specifically describing the technology in the present disclosure, and thus connections for achieving functions of the present disclosure are not restricted by the connections described.

Division to the functional blocks in a block diagram is also an example. Multiple functional blocks may be achieved as a single functional block, a single functional block may be divided into multiple functional blocks, or part of functions may be transferred to another functional block. Functions of multiple functional blocks having similar functions may be processed in parallel or on a time-division basis by single hardware or software.

The information processing system of the present disclosure is applicable to devices or systems for processing information on driving of a vehicle.

What is claimed is:

1. An information processing system comprising:
a safe behavior determiner configured to classify parameter values each indicating a travel state of a vehicle into a plurality of ranges based on travel safety, and determine a safe behavior for the vehicle, the safe behavior adjusting the travel state of the vehicle such that the parameter values fall under a range of the plurality of ranges, the range having a high level of the travel safety;
a clustering range controller configured to change a position of a boundary between the plurality of ranges in accordance with an external environment of the vehicle; and
a safety determiner configured to acquire a behavior estimation result of the vehicle and the safe behavior determined by the safe behavior determiner, and determine a behavior control of the vehicle based on at least one of the acquired behavior estimation result and the safe behavior.

2. The information processing system according to claim 1, further comprising a reporter configured to provide a current range of the plurality of ranges to a driver of the vehicle, the current range corresponding to a travel state of the vehicle.

3. The information processing system according to claim 1,
wherein the external environment includes at least one of information on a road on which the vehicle travels, information on travel environment of the vehicle, and information on travel experience of the road on which the vehicle travels.

4. The information processing system according to claim 1, further comprising an incorrectness risk determiner configured to determine whether or not the behavior estimation result carries incorrectness risk,
wherein the incorrectness risk determiner determines that the behavior estimation result carries the incorrectness risk when correctness of the behavior estimation result is equal to or less than a threshold, and
the safety determiner selects the behavior estimation result or the safe behavior based on a result determined by the incorrectness risk determiner.

5. The information processing system according to claim 1,
wherein the behavior estimation result is a result estimated, using machine learning, based on at least one of information on surroundings of the vehicle and information on a travel state of the vehicle.

6. An information processing method comprising:
acquiring parameter values each indicating a travel state of a vehicle;
classifying the parameter values into a plurality of ranges based on travel safety;
changing a position of a boundary between the plurality of ranges in accordance with an external environment of the vehicle;
determining a safe behavior for the vehicle, the safe behavior adjusting the travel state of the vehicle such that the parameter values fall under a range of the plurality of ranges, the range having a high level of the travel safety;
acquiring a behavior estimation result of the vehicle; and
determining a behavior control of the vehicle based on at least one of the behavior estimation result and the safe behavior.

7. A non-transitory recording medium recording a program allowing a computer to execute:
acquiring parameter values each indicating a travel state of a vehicle;
classifying the parameter values into a plurality of ranges based on travel safety;
changing a position of a boundary between the plurality of ranges in accordance with an external environment of the vehicle;
determining a safe behavior for the vehicle, the safe behavior adjusting the travel state of the vehicle such that the parameter values fall under a range of the plurality of ranges, the range having a high level of the travel safety;
acquiring a behavior estimation result of the vehicle; and
determining behavior control of the vehicle based on at least one of the behavior estimation result and the safe behavior.
